(19) United States
(12) Patent Application Publication
(10) Pub. No.: US 2005/0287455 A1
(43) Pub. Date: Dec. 29, 2005

(54) Electrophotographic photoreceptor and image forming apparatus provided with the same

(75) Inventors: Akiko Uchino, Tenri-shi (JP); Kotaro Fukushima, Kawanishi-shi (JP); Takuya Arimura, Osaka (JP)

Correspondence Address: NIXON & VANDERHYE, PC, 901 NORTH GLEBE ROAD, 11TH FLOOR, ARLINGTON, VA, 22203, US

(73) Assignee: Sharp Kabushiki Kaisha, Osaka (JP)

(21) Appl. No.: 11/159,270

(22) Filed: Jun. 23, 2005

(30) Foreign Application Priority Data
Jun. 23, 2004 (JP) P2004-185223

(51) Int. Cl. G03G 5/14

(52) U.S. Cl. 430/60

(57) ABSTRACT

An electrophotographic photoreceptor having good electric properties such as chargeability, sensitivity and responsibility, having good oxidizing gas resistance, and having good property stability in that the good electric properties thereof do not worsen in repeated use, is provided. An undercoat layer is provided between the conductive support and the photosensitive layer of an electrophotographic photoreceptor, and the undercoat layer contains an amine compound expressed by the following formula (1) added thereto.

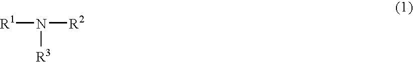

### BACKGROUND OF THE INVENTION

1. Field of the Invention

The present invention relates to an electrophotographic photoreceptor that is used to form an image according to an electrophotography process and image forming apparatus provided with the electrophotographic photoreceptor:

2. Description of the Related Art

An electrophotographic image forming apparatus for forming an image through electrophotography is much used as duplicators, printers and facsimiles. In the electrophotographic image forming apparatus, an image is formed according to an electrophotographic process of using a photoconductive electrophotographic photoreceptor (hereinafter this may be simply referred to as “photoreceptor”) The electrophotographic process is a type of information recording means of utilizing the photoconductive phenomenon of a photoreceptor, and it is as follows.

A photoreceptor is first put in the dark, and its surface is uniformly charged by a charging unit and then exposed to light corresponding to the image information applied thereto to thereby selectively discharge the surface charge of the exposed area. As a result, the surface charge remains only in the non-exposed area of the photoreceptor, therefore producing a difference between the surface charge of the exposed area and that of the non-exposed area, and an electrostatic latent image is thereby formed. Next, colored charge particles referred to as toner are adhered to the thus formed electrostatic latent image by electrostatic attraction, and a visible toner image is thereby formed. Then, if desired, the thus formed toner image is transferred onto a transfer material such as paper, and fixed thereon to form the intended image.

The basic characteristics necessary for the photoreceptor for use in the electrophotography of forming an image according to the electrophotographic process mentioned above are that it has good electric properties, for example, it has good charge retentive capability and hardly discharges in the dark while it has good photosensitivity and readily discharges through exposure to light. The others also necessary for the photoreceptor are that its electric properties as above are stable even in repeated service so that it can form homogeneous images for a long period of time, and it has good electric characteristic stability (this may be hereinafter simply referred to as “characteristic stability”).

In recent years, the electrophotography has been utilized not restricted only to the field of copying machines but utilized also in the field, for example, of printing plate materials, slide films or microfilms for which photography has been used so far, and it is also applied to high speed printers using lasers, light emitting diodes (abbreviated as LED) or cathode ray tubes (abbreviated as CRT) as a light source. Along with extension of the application range of the electrophotography, the demand for the electrophotographic photoreceptor has become higher and more versatile.

An electrophotographic photoreceptor is constituted by laminating a photosensitive layer containing a photoconductive material on a conductive support. As the electrophotographic photoreceptor, an inorganic photoreceptor having a photosensitive layer mainly containing an inorganic photoconductive material such as selenium, zinc oxide or cadmium sulfide has been used generally. While the inorganic photoreceptor has basic properties as the photoreceptor to some extent, it involves a problem such that the formation of the film for the photosensitive layer is difficult and plasticity is poor, and the production cost is expensive. Further, since the inorganic photoconductive material generally has high toxicity and suffers from great restriction in view of production and handling.

As described above, since the inorganic photoconductive material and the inorganic photoreceptor using the same involve many drawbacks, research and development have been progressed for organic photoconductive materials. Further, the organic photoconductive material has been studied and developed generally in recent years and it has been utilized not only for electrostatic recording devices such as the electrophotographic photoreceptor but also has been applied, for example, to sensor materials or organic electro luminescent (abbreviated as EL) devices.

The organic photoreceptor using the organic photoconductive material has advantages such that the film formation property for the photosensitive layer is favorable and the flexibility is excellent, as well as it is light in the weight, excellent in the transparency, and a photoreceptor showing good sensitivity to a wavelength region over a wide range can be designed easily by an appropriate sensitizing method. Thus, the organic photoreceptor has been under development as a predominant candidate for the electrophotographic photoreceptor.

Recently, a function-separated electrophotographic photoreceptor has been developed, of which the charge generating function and the charge transporting function are separately attained by different substances. The function-separated photoreceptor of the type, in which the charge generating substance and the charge transporting substance differ from each other, has broad latitude in selecting the materials for the charge generating substance and the charge transporting substance, and therefore has the advantage in that those having any desired characteristics are relatively readily produced. For these reasons, the function-separated photoreceptor of the type is widely used in the art. In the initial stage thereof, organic photoreceptors have some defects in point of their sensitivity and durability, but such defects have now been significantly overcome by the development of the function-separated electrophotographic photoreceptor.

The function-separated photoreceptor is grouped into two; one is a single-layered photoreceptor having a photosensitive layer in which a charge generating substance and a charge transporting substance are co-dispersed in a binder resin, and the other is a laminate-structured photoreceptor having a lamination structure of a charge generating layer with a charge generating substance dispersed therein and a charge transporting layer with a charge transporting substance dispersed therein.

For the laminate-structure photoreceptor, much used is a normal two-layered photoreceptor that comprises a charge transporting layer formed on the surface side thereof and a charge generating layer formed on the conductive support side thereof. In the normal two-layered photoreceptor, a charge transporting layer is laminated on a charge generating layer and the charge transporting layer generally has only a hole transporting function. Therefore, the photoreceptor of the type is sensitive while it is charged negatively, and it is essentially used under negative charge. On the other hand, a reverse two-layered photoreceptor has been developed as a laminate-structure photoreceptor usable under positive charge, in which a charge transporting layer is formed on the conductive support side of the photoreceptor and a charge generating layer is formed on the surface side thereof.

However, the conventional photoreceptors have various drawbacks in that their characteristic stability is insufficient, therefore causing fatigue deterioration such as charge potential reduction, residual potential increase and surface potential reduction and resulting in resolution reduction and image failures such as white spots and black streaks. White spots as referred to herein are caused by the phenomenon that toner did not adhere to the part to which it is to be adhered. Black streaks also as referred to herein are caused by the phenomenon that toner adhered like streaks to the part to which it is to be adhered and to the other part to which it is not to be adhered.

The cause of the fatigue deterioration will be as follows: oxidizing gas such as ozone released from a corona discharge-type charger (hereinafter referred to as corona-discharge charger) that is used as a charging unit in a charging process, and nitrogen oxides formed through reaction of the released ozone and nitrogen in air may oxidize the material that constitutes the surface of the photoreceptor and the photosensitive layer to thereby damage the photoreceptor, for example, lower the surface resistance thereof.

For solving the problem of fatigue deterioration of photoreceptor in point of the image forming apparatus, there is proposed a method of providing an exhaust system in the apparatus so as to efficiently release the oxidizing gas around the corona-discharge charger. However, the method of providing such an exhaust system in the image forming apparatus produces another problem in that the constitution of the apparatus is complicated.

Another method is also tried, which comprises improving the gas-barrier property of a photosensitive layer so as to make the layer hardly transmit oxidizing gas therethrough to thereby retard the fatigue deterioration of the photoreceptor. However, a photosensitive layer having a satisfactory gas barrier property is not as yet realized.

Still another method is tried, which comprises adding an antioxidant and a stabilizer to a photosensitive layer so as to improve the resistance of the photoreceptor to oxidizing gas (hereinafter referred to oxidizing gas resistance). For example, there is proposed a method of adding a hindered phenol-type antioxidant such as a compound having a triazine ring and a hindered phenol skeleton to a photosensitive layer (see Japanese Unexamined Patent Publication JP-A 62-105151 (1987)).

As another related art technique, also proposed is a method of adding an additive such as hindered phenol-type antioxidant, phosphite-type antioxidant or amine-type antioxidant to a specific arylamine compound-containing photosensitive layer (see Japanese Unexamined Patent Publication JP-A 8-292587 (1996)). As still another related art technique, proposed is a method of adding a hindered amine skeleton-having compound and a specific structure-having amine compound such as tribenzylamine to a photosensitive layer (see Japanese Unexamined Patent Publication JP-A10-282696 (1998)).

The hindered phenol skeleton-having compound means a phenol compound that has a bulky substituent such as a branched alkyl group, a cycloalkyl group, an aryl group or a heterocyclic group at the position adjacent to the phenolic hydroxyl group therein. The hindered amine skeleton-having compound means an amine compound in which the hydrogen atom of the amino group is substituted with a bulky substituent such as a branched alkyl group, a cycloalkyl group, an aryl group or a heterocyclic group.

According to the technique disclosed in JP-A 62-105151, a hindered phenol-type antioxidant is added to a photosensitive layer so as to prevent the fatigue deterioration of the layer. However, this is still problematic in that, in repeated use for a long period of time, there occur image failures such as halftone (abbreviated to HF) black streaks. This may be because of the following reasons: since the oxidizing gas resistance of the photoreceptor is not satisfactory, the material that constitutes the photosensitive layer is deteriorated by the ozone and the like remaining around the corona-discharge charger while the image forming apparatus is stopped, and, as a result, the charging property of the photoreceptor may change. The HF black streaks as referred to herein are caused by the phenomenon that, when the image forming apparatus is stopped for a while after image formation service and then it is driven again to form a halftone image, there occurs a part with toner adhering thereto like streaks in the site of a recording material that corresponds to the part to which a toner image is transferred from the site of the photoreceptor positioned near to the charger while the apparatus is stopped. The halftone image also referred to herein means an image with black-and-white dot gradation for varying image density presentation.

When the antioxidant disclosed in JP-A 62-105151, JP-A 8-292587 and JP-A 10-282696 is added to a photosensitive layer, then it lowers the sensitivity and the responsibility owing to the change of the wavelength to which the layer is sensitive, and, as a result, in a repeated electrophotographic process of charging, exposure and discharging, there occurs a problem in that the charging potential lowers and the residual potential increases.

To that effect, no one has heretofore succeeded in realizing a photoreceptor that satisfies both good electric property and good property stability.

### SUMMARY OF THE INVENTION

An object of the invention is to provide an electrophotographic photoreceptor having good electric properties such as chargeability, sensitivity and responsibility, having good oxidizing gas resistance, and having good property stability in that the good electric properties thereof do not worsen in repeated use, and to provide an image forming apparatus provided with the photoreceptor.

We, the present inventors have assiduously studied so as to solve the problems as above, and, as a result, have found that when a specific amine compound is added to an undercoat layer provided between a conductive support and a photosensitive layer that constitute an electrophotographic photoreceptor, then the photosensitive layer exhibits good resistance to oxidation with oxidizing gas such as ozone and therefore the electrophotographic photoreceptor may have improved oxidizing gas resistance while keeping its good electric properties such as chargeability, sensitivity and responsibility. On the basis of this finding, we have completed the invention.

Specifically, the invention provides an electrophotographic photoreceptor comprising:
a conductive support formed of a conductive material;
a photosensitive layer provided on the conductive support and containing a charge generating substance and a charge transporting substance; and
an undercoat layer provided between the conductive support and the photosensitive layer and containing an amine compound expressed by the following general formula (1): 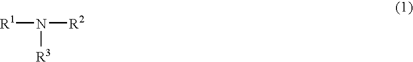
wherein R¹ and R² each represent an optionally-substituted aryl, heterocyclic, aralkyl, alkyl, cycloalkyl or heterocycloalkyl group; and R³ represents an optionally-substituted aralkyl, alkyl or cycloalkyl group, or a hydrogen atom.

In the invention, it is preferable that in the general formula (1), R¹ and R² each represent an optionally-substituted aryl or aralkyl group, and R³ represents an optionally-substituted aralkyl group, an optionally-substituted alkyl group having from 1 to 4 carbon atoms, or a hydrogen atom.

In the invention, it is preferable that in the general formula (1), R¹, R² and R³ each represent an optionally-substituted aralkyl group.

In the invention, it is preferable that the amine compound expressed by the general formula (1) is an amine compound expressed by the following structural formula (1a):

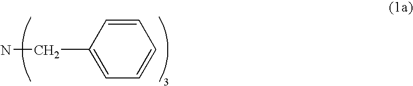

In the invention, it is preferable that a content of the amine compound expressed by the general formula (1) to be in the undercoat layer is 0.1% by weight or more and 30% by weight or less of the total solid content of the undercoat layer.

In the invention, it is preferable that the content of the amine compound expressed by the general formula (1) to be in the undercoat layer is 1% by weight or more and 10% by weight or less of the total solid content of the undercoat layer.

The invention also provides an image forming apparatus comprising:
the electrophotographic photoreceptor mentioned above;
charging means for charging the electrophotographic photoreceptor;
exposure means for exposing the charged electrophotographic photoreceptor to light; and
developing means for developing the electrostatic latent image formed through exposure.

According to the invention, an undercoat layer is provided between the conductive support and the photosensitive layer of an electrophotographic photoreceptor (hereinafter this may be simply referred to as “photoreceptor”), and this contains an amine compound expressed by the general formula (1). Having the constitution, the photoreceptor may have good oxidizing gas resistance such as ozone resistance and nitrogen oxide resistance, not detracting from its electric properties such as chargeability, sensitivity and responsibility. Accordingly, when an undercoat layer is provided between the conductive support and the photosensitive layer and when an amine compound expressed by the general formula (1) is incorporated into the undercoat layer as so mentioned hereinabove, then an electrophotographic photoreceptor is realized, having good electric properties such as chargeability, sensitivity and responsibility, having good oxidizing gas resistance, and having good property stability in that the good electric properties thereof do not worsen in repeated use.

According to the invention, among the amine compounds expressed by the general formula (1), in the general formula (1), preferably, R¹ and R² each represent an optionally-substituted aryl or aralkyl group, and R³ represents an optionally-substituted aralkyl group, an optionally-substituted alkyl group having from 1 to 4 carbon atoms, or a hydrogen atom; more preferably, R¹, R² and R³ each represent an optionally-substituted aralkyl group; even more preferably, the amine compound expressed by the general formula (1) is an amine compound expressed by the structural formula (1a). The amine compounds of those cases exhibit an extremely excellent inhibiting effect against fatigue deterioration of photoreceptors by oxidizing gas. Accordingly, when any of these amine compounds is incorporated into the undercoat layer, then an electrophotographic photoreceptor of high reliability is realized, having extremely excellent oxidizing gas resistance and having stable electric properties in repeated use.

According to the invention, the amount of the amine compound expressed by the general formula (1) to be in the undercoat layer is 0.1% by weight or more and 30% by weight or less of the total solid content of the undercoat layer, more preferably 1% by weight or more and 10% by weight or less thereof. Defining the content of the amine compound expressed by the general formula (1) in the undercoat layer to fall within the range as above makes it possible to realize an electrophotographic photoreceptor having especially excellent oxidizing gas resistance. The undercoat layer that contains the amine compound expressed by the general formula (1) does not so much contribute to the charge generation and the charge transportation in the electrophotographic photoreceptor of the invention. Therefore, in the invention, the content of the amine compound expressed by the general formula (1) in the undercoat layer may be defined in any desired manner to fall within the range as above, not detracting from the electric properties such as the chargeability, the sensitivity and the responsibility of the photoreceptor. Accordingly, the invention realizes an electrophotographic photoreceptor having good electric properties such as chargeability, sensitivity and responsibility, having good oxidizing gas resistance, and having good property stability in that the photoreceptor may have good electric properties even in repeated use, like in the initial stage just after use thereof.

According to the invention, as the electrophotographic photoreceptor of the image forming apparatus is used the electrophotographic photoreceptor of the invention that has good electric properties such as chargeability, sensitivity and responsibility, has good oxidizing gas resistance, and has good property stability in that the good electric properties thereof do not worsen in repeated use. Accordingly, the image forming apparatus has good durability and realizes long-term stable image formation with high resolution, and the images formed have high quality with no image defects.

### BRIEF DESCRIPTION OF THE DRAWINGS

Other and further objects, features, and advantages of the invention will be more explicit from the following detailed description taken with reference to the drawings wherein:

FIG. 1 is a partial cross-sectional view schematically showing the constitution of an electrophotographic photoreceptor according to a first embodiment of the invention;

FIG. 2 is a partial cross-sectional view schematically showing the constitution of an electrophotographic photoreceptor according to a second embodiment of the invention; and

FIG. 3 is an arrangement side view graphically showing the constitution of an image forming apparatus according to a third embodiment of the invention.

### DETAILED DESCRIPTION OF THE PREFERED EMBODIMENTS

Now referring to the drawings, preferred embodiments of the invention are described below.

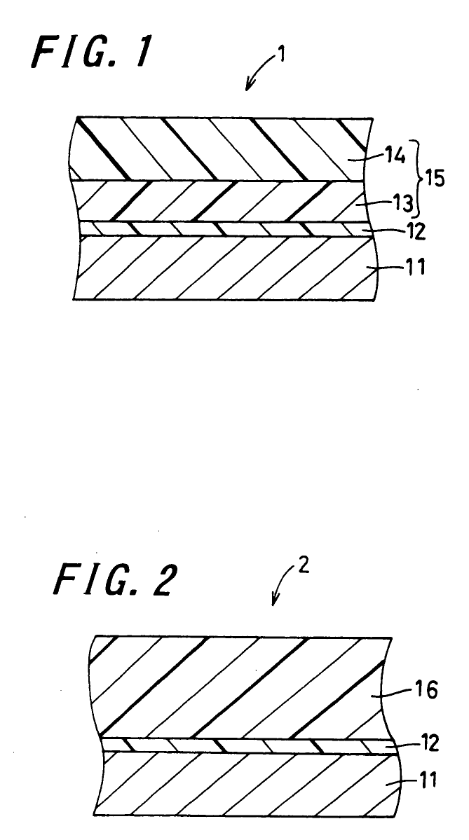

FIG. 1 is a partial cross-sectional view schematically showing the constitution of an electrophotographic photoreceptor 1 according to a first embodiment of the invention. The electrophotographic photoreceptor 1 comprises a sheet-like conductive support 11 of a conductive material, an undercoat layer 12 laminated on the conductive support 11, a charge generating layer 13 laminated on the undercoat layer 12 and containing a charge generating substance, and a charge transporting layer 14 further laminated on the charge generating layer 13 and containing a charge transporting substance. The photoreceptor 1 is a laminate-structure photoreceptor, in which the charge generating layer 13 and the charge transporting layer 14 constitute a photosensitive layer 15.

The conductive support 11 serves as an electrode of the photoreceptor 1 and also serves as the supporting members for the respective layers 12, 13 and 14. The shape of the conductive support is not limited to sheet, but may include any others such as cylindrical, columnar, tabular, film or belt supports.

The conductive material constituting the conductive support 11 may be (a) a metal material such as aluminium, stainless steel, copper, nickel, or (b) an insulating substance such as polyester film, phenolic resin pipe or paper pipe coated with a conductive layer of aluminium, copper, palladium, tin oxide, indium oxide or the like. Regarding the conductivity level thereof, the conductive support 11 preferably has a volume resistivity of at most 10¹⁰ Ω·cm. If desired, the surface of the conductive support 11 may be oxidized so as to control the volume resistivity thereof to the level as above.

The undercoat layer 12 to be provided on the conductive support 11 may comprise an amine compound expressed by the following general formula (1) and a binder material to bind the amine compound.

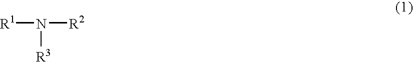

In the general formula (1), R¹ and R² each represent an aryl group, a heterocyclic group, an aralkyl group, alkyl group a cycloalkyl group or a heterocycloalkyl group. The aryl group, heterocyclic group, aralkyl group, alkyl group cycloalkyl group and heterocycloalkyl group represented by R¹ and R² may be optionally substituted. The heterocycloalkyl group is a monovalent group derived from a cycloalkane having a hetero atom between the carbon atoms, by removing one hydrogen atom bonding to the carbon atom of the cycloalkane.

In the general formula (1), the aryl group represented by R¹ and R² includes a phenyl group, a naphthyl group, an anthryl group, a pyrenyl group, a biphenylyl group, a terphenyl group. Among these, preferred is a monocyclic or bicyclic aryl group such as phenyl group, naphthyl group, biphenylyl group; and more preferred is a phenyl group.

In the general formula (1), the heterocyclic group represented by R¹ and R² may be a 5-membered, 6-membered or condensed heterocyclic group, preferably a 5-membered heterocyclic group having a hetero atom of oxygen atom, nitrogen atom, sulfur atom, selenium atom or tellurium atom, preferably oxygen atom, nitrogen atom or sulfur atom, such as a pyrrolyl group, a thienyl group, a furyl group, a thiazolyl group, a benzofuryl group, a benzothiophenyl group, a benzothiazolyl group, a benzoxazolyl group, a carbazolyl group.

In the general formula (1), the aralkyl group represented by R¹ and R² may be an aralkyl group in which the aryl moiety is preferably a monocyclic or bicyclic aryl group such as a phenyl group, a naphthyl group, an anthryl group, a pyrenyl group, a biphenylyl group or a terphenyl group, more preferably a phenyl group, for example, including a benzyl group, a phenethyl group, a 1-naphthylmethyl group, a 2-(1-naphthyl)ethyl group. Among these, more preferred is an aralkyl group in which the alkyl moiety has from 1 to 4 carbon atoms, and most preferred are benzyl group and phenetyl group.

In the general formula (1), the alkyl group represented by R¹ and R² may be a linear alkyl group such as methyl group, ethyl group, n-propyl group, n-butyl group, n-hexyl group; or a branched alkyl group such as isopropyl group, t-butyl group, neopentyl group. Among these, preferred is an alkyl group having from 1 to 4 carbon atoms.

In the general formula (1), the cycloalkyl group represented by R¹ and R² includes a cyclopentyl group, a cyclohexyl group, cycloheptyl group. Among these, preferred is a cycloalkyl group having from 5 to 8 carbon atoms.

In the general formula (1) the heterocycloalkyl group represented by R¹ and R² may be a heterocycloalkyl group having a hetero atom of oxygen atom, nitrogen atom, sulfur atom, selenium atom or tellurium atom, preferably oxygen atom, nitrogen atom or sulfur atom and having from 2 to 6 carbon atoms, preferably 4 or 5 carbon atoms, including, for example, a pyrrolidinyl group, a piperidyl group, a tetrahydrofuryl group, a tetrahydropyranyl group, an imidazolidinyl group, a morpholinyl group.

In the general formula (1), the aryl group, heterocyclic group, aralkyl group, alkyl group, cycloalkyl group and heterocycloalkyl group represented by R¹ and R² may be optionally substituted. The substituent for these includes, for example, an alkyl group preferably having from 1 to 4 carbon atoms, such as methyl group, ethyl group, propyl group; an alkoxy group preferably having from 1 to 4 carbon atoms, such as alkyl group, methoxy group, ethoxy group, propoxy group; a halogen atom such as fluorine atom, chlorine atom, bromine atom; a heterocyclic group such as thienyl group, furyl group; an aryl group such as phenyl group, naphthyl group; an aralkyl group such as benzyl group, phenethyl group; a cycloalkyl group such as cyclohexyl group; a hydroxyl group, a carboxyl group, a cyano group, a nitro group, an amino group, a mono-substituted or di-substituted amino group. Among these, an alkyl group having from 1 to 4 carbon atoms is preferred as an substituent for the optionally substituted aryl group, heterocyclic group and aralkyl group represented by R¹ and R².

In the general formula (1), R³ represents an aralkyl group, an alkyl group, a cycloalkyl group, or a hydrogen atom. The aralkyl group, alkyl group and cycloalkyl group represented by R³ may be optionally substituted.

In the general formula (1), the aralkyl group represented by R³ may be an aralkyl group in which the aryl moiety is preferably a monocyclic or bicyclic aryl group such as phenyl group, naphthyl group, anthryl group, pyrenyl group, biphenylyl group or terphenyl group, more preferably a phenyl group, including, for example, a benzyl group, a phenethyl group, a 1-naphthylmethyl group, a 2-(1-naphthyl)ethyl group. Among these, more preferred is an aralkyl group in which the alkyl moiety has from 1 to 4 carbon atoms, and most preferred are benzyl group and phenetyl group.

In the general formula (1), the alkyl group represented by R³ includes a linear alkyl group such as methyl group, ethyl group, n-propyl group, n-butyl group, n-hexyl group; and branched alkyl group such as isopropyl group, t-butyl group, neopentyl group. Among these, preferred is an alkyl group having from 1 to 4 carbon atoms.

In the general formula (1), the cycloalkyl group represented by R³ includes a cyclopentyl group, a cyclohexyl group, a cycloheptyl group. Among these, preferred is a cycloalkyl group having from 5 to 8 carbon atoms.

In the general formula (1), the aralkyl group, the alkyl group and the cycloalkyl group represented by R³ may be optionally-substituted. The substituent for these includes, for example, an alkyl group preferably having from 1 to 4 carbon atoms, such as methyl group, ethyl group, propyl group; an alkoxy group preferably having from 1 to 4 carbon atoms, such as methoxy group, ethoxy group, propoxy group; a halogen atom such as fluorine atom, chlorine atom, bromine atom; a heterocyclic group such as thienyl group, furyl group; an aryl group such as phenyl group, naphthyl group; an aralkyl group such as benzyl group, phenethyl group; a cycloalkyl group such as cyclohexyl group; a hydroxyl group, a carboxyl group, a cyano group, a nitro group, an amino group, a mono-substituted or di-substituted amino group. Among these, an alkyl group having from 1 to 4 carbon atoms is preferred as an substituent for the optionally substituted aralkyl group represented by R³.

The amine compound expressed by the general formula (1) functions as an antioxidant. The antioxidant such as the amine compound expressed by the general formula (1) prevents a photosensitive layer from being oxidized by oxidizing gas such as ozone and nitrogen oxide generated in a charging process, thereby inhibiting the fatigue deterioration of photoreceptor. For that purpose, in general, the antioxidant is added to the constitutive layers of the photosensitive layer, such as the charge transporting layer and/or the charge generating layer. However, when the antioxidant is added to the charge transporting layer, then it produces a problem in that it worsens the electric properties such as the chargeability, the sensitivity and the responsibility and therefore the photoreceptor could not have good electric properties enough for practical use in the initial stage of its use. On the other hand, the charge generating layer is thin, for example, having a thickness of from 0.05 to 5 μm, and therefore, the amount of the antioxidant that may be added to the layer is limited. If too much antioxidant is added the layer, then it detracts from the charge generation by the charge generating substance and the sensitivity of the photoreceptor may be thereby lowered.

As opposed to this, in this embodiment of the invention, the undercoat layer 12 is provided between the conductive support 11 and the photosensitive layer 15, and an amine compound expressed by the general formula (1) is added to the undercoat layer 12. The undercoat layer 12 functions as a barrier layer that prevents charge flowing into the photosensitive layer 15 from the conductive support 11, and it contributes little to charge transportation and charge generation in the photoreceptor 1. Accordingly, in this embodiment, the electric properties such as the chargeability, the sensitivity and the responsibility of the photoreceptor may be kept good as compared with the case where an amine compound expressed by the general formula (1) is added to the photosensitive layer 15. In addition, since the amine compound expressed by the general formula (1) is added to the undercoat layer 12, the latitude in selecting the material to constitute the photosensitive layer 15 may be broadened, and therefore, the latitude in designing the photoreceptor 1 in any desired manner may also be broadened and the producibility of the photoreceptor 1 may be increased. Another advantage is that the production costs of the photoreceptor 1 may be reduced.

In this connection, since the undercoat layer 12 underlies the photosensitive layer 15 and is therefore not exposed to oxidizing gas, there may be a possibility that even though an antioxidant is added to the undercoat layer 12, it could not sufficiently prevent the fatigue deterioration of the photoreceptor 1 by oxidizing gas. However, adding the antioxidant of the amine compound expressed by the general formula (1) to the undercoat layer 12 as in this embodiemnt is more effective for inhibiting the fatigue deterioration of the photoreceptor by oxidizing gas, than adding it to the photosensitive layer 15. Specifically, in this embodiment, the photoreceptor 1 may have good oxidizing gas resistance such as ozone resistance and nitrogen oxide resistance, not detracting from its electric properties such as chargeability, sensitivity and responsibility.

Accordingly, as in this embodiment, adding an amine compound expressed by the general formula (1) to the undercoat layer 12 realizes the photoreceptor 1 that has good electric properties such as chargeability, sensitivity and responsibility, has good oxidizing gas resistance and has good property stability in that the good electric properties thereof do not worsen in repeated use. Accordingly, the photoreceptor 1 of this embodiment has the advantage in that it is hardly influenced by the oxidizing gas such as ozone and nitrogen oxide generated by a charger such as a corona-discharge charger, and it may have good electric properties enough for practical use even after used repeatedly. Using the photoreceptor 1 of this embodiment provides stable and good images of high quality with no image defects that maybe caused by active species such as ozone and nitrogen oxide generated in a charging process, for a long period of time. The undercoat layer 12 functions as an adhesive layer for the conductive support 11 and the photosensitive layer 15. Therefore, providing the undercoat layer 12 as in this embodiment is effective for preventing the photosensitive layer 15 from being peeled from the conductive support 11 and therefore the mechanical durability of the photoreceptor 1 is thereby improved.

Among the amine compounds expressed by the general formula (1), especially preferred from the viewpoint of preventing the fatigue deterioration of the photoreceptor 1 are those expressed by the general formula (1) where R¹ and R² each represent an optionally-substituted aryl or aralkyl group, and R³ represents an optionally-substituted aralkyl group, an optionally-substituted alkyl group having from 1 to 4 carbon atoms, or a hydrogen atom. Among these, preferred are amine compounds expressed by the general formula (1) where at least one of R¹, R² and R³ represents an optionally-substituted aralkyl group. Among these, more preferred are amine compounds expressed by the general formula (1) where R¹, R² and R³ each represent an optionally-substituted aralkyl group. Even more preferred are Compounds No. 1 and No. 4 in Table 1 given below and most preferred is an amine compound having the following structural formula (1a), Compound No. 1 in Table 1.

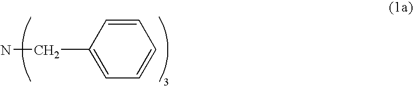

These amine compounds are especially effective for preventing the fatigue deterioration of the photoreceptor 1 by oxidizing gas. Accordingly, using the amine compounds realizes the photoreceptor 1 of high reliability, having good oxidizing gas resistance and having good and stable electric properties in repeated use.

Specific examples of the amine compounds expressed by the general formula (1) are Compound No. 1 to Compound No. 8 mentioned below in Table 1, to which, however, the amine compounds expressed by the general formula (1) should not be limited.

TABLE 1

| Compound | |
|---|---|
| No. | Structural formula |
| 1 | 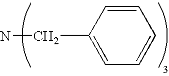 |
| 2 | 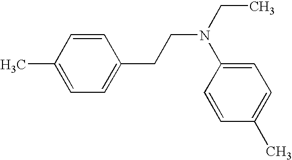 |
| 3 | 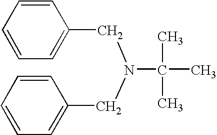 |
| 4 | 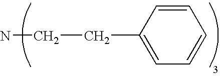 |
| 5 | 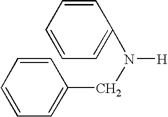 |
| 6 | 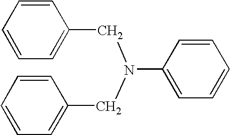 |
| 7 | 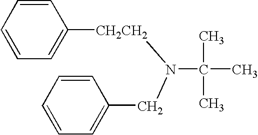 |
| 8 | 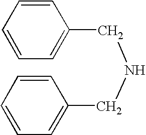 |

Regarding the amine compound expressed by the general formula (1), for example, one or more selected from the group of Compound No. 1 to Compound No. 8 in Table 1 may be used herein either singly or as combined.

The amount of the amine compound expressed by the general formula (1) to be used herein, or that is the content of the amine compound expressed by the general formula (1) to be in the undercoat layer 12 is preferably 0.1% by weight or more and 30% by weight or less of the total solid content of the undercoat layer 12, more preferably 1% by weight or more and 10% by weight or less thereof. Selecting the amount of the amine compound expressed by the general formula (1) for use herein to fall within the range as above realizes the photoreceptor 1 having especially good oxidizing gas resistance.

Regarding the amount of the amine compound expressed by the general formula (1) to be used, for example, when it is added to the charge generating layer, its amount must be selected within a range within which it does not detract from charge generation by the charge generating substance in the layer. In addition, since the charge generating layer is thin, as so mentioned hereinabove, a large amount of the amine compound expressed by the general formula (1) could not be added to it. However, in this embodiemnt, since the undercoat layer 12 to which the amine compound expressed by the general formula (1) is added has a thickness of, for example, from 0.1 to 10 μm and since it does not so much contributes to the charge generation and the charge transportation in the photoreceptor 1, the content of the amine compound expressed by the general formula (1) to be in the undercoat layer 12 may be defined in a broad range as above, not detracting from the electric properties such as the chargeability, the sensitivity and the responsibility of the photoreceptor 1.

Accordingly, defining the content of the amine compound expressed by the general formula (1) in the layer to fall within the range as above realizes the photoreceptor 1 that has good electric properties such as chargeability, sensitivity and responsibility, has good oxidizing gas resistance and has good property stability in that it has good electric properties even in repeated use, like in the initial stage just after use thereof. In case where the content of the amine compound expressed by the general formula (1) in the undercoat layer 12 is smaller than 0.1% by weight of the total sold content of the layer, then the photoreceptor 1 could not have good oxidizing gas resistance. On the other hand, in case where the content of the amine compound expressed by the general formula (1) in the undercoat layer 12 is much larger than 30% by weight of the total sold content of the layer, then the electric properties such as the chargeability, the sensitivity and the responsibility of the photoreceptor 1 may significantly worsen with the result that the charging potential significantly lowers and the residual potential increases due to repetition of use of the photoreceptor.

The binder material in the undercoat layer 12 to bind the amine compound expressed by the general formula (1) therein includes, for example, resins such as polyamide, polyurethane, polyvinyl alcohol, polyvinyl pyrrolidone, polyacrylamide; celluloses such as cellulose, nitrocellulose; and gelatin, starch, casein. Among these, preferred is polyamide resin as its compatibility with the amine compound expressed by the general formula (1) is good and its adhesiveness to the conductive support 11 is also good. Among the polyamide resin, more preferred is alcohol-soluble nylon resin. The alcohol-soluble nylon resin includes, for example, modified nylon resin such as N-methoxymethylated nylon; and copolymerized nylon resin such as 6-nylon, 6,6-nylon, 6,10-nylon, 11-nylon, 12-nylon.

In order to control a volume resistivity, conductive particles of titanium oxide, tin oxide or aluminium oxide may be dispersed in the undercoat layer 12. Adding such conductive particles to the undercoat layer 12 is effective for controlling the volume resistivity of the undercoat layer 12 and for improving the responsibility of the photoreceptor 1. In addition, various additives which are generally used in the field may be dispersed into the undercoat layer 12.

The undercoat layer 12 may be formed, for example, by adding an amine compound expressed by the general formula (1), a binder material such as that mentioned above, and optionally various additives such as conductive particles mentioned above, to a suitable solvent, and dissolving and/or dispersing them therein to prepare an undercoat layer forming liquid, and applying the coating liquid to the surface of a conductive support 11. For coating with the undercoat layer forming liquid, for example, employable is a method of spraying, bar coating, roll coating, blade coating, ring coating or dipping.

For the solvent for the undercoat layer forming coating liquid, employable are water or various organic solvents, or their mixed solvents. Above all, preferred area single solvent of water or alcohol such as methanol, ethanol or butanol; and a mixed solvent of water and alcohol; two or more different types of alcohols; and alcoholic mixed solvents prepared by mixing an alcohol with a ketone such as acetone, an ether such as dioxolane, or a halogenohydrocarbon such as dichloroethane, chloroform, trichloroethane.

Preferably, the thickness of the undercoat layer 12 is 0.1 μm or more and 10 μm or less. In case where the thickness of the undercoat layer 12 is smaller than 0.1 μm, then it could not sufficiently prevent the fatigue deterioration of the photoreceptor 1. In the case, in addition, charges may flow into the photosensitive layer 15 from the conductive support 11, and the charge retentive capability of the photoreceptor 1 may be thereby lowered. On the other hand, in case where the thickness of the undercoat layer 12 is larger than 10 μm, then the responsibility of the photoreceptor 1 may worsen.

The charge generating layer 13 provided on the undercoat layer 12 contains a charge generating substance. Absorbing light such as visible light to generate free charges, the charge generating substance is not specifically defined and may be any known one. For example, it includes inorganic pigment, organic pigment and organic dye. The inorganic pigment includes selenium and its alloy, arsenic-selenium, cadmium sulfide, zinc oxide, amorphous silicon, and other inorganic photoconductors. The organic pigment includes phthalocyanine compounds, azo compounds, quinacridone compounds, polycyclic quinone compounds and perylene compounds. The organic dye includes thiapyrylium salts and squalilium salts.

Among these, preferred are organic photoconductive compounds such as organic pigment and organic dye. Of the organic photoconductive compounds, more preferred are phthalocyanine compounds; and titanylphthalocyanine compounds of the following general formula (2) are especially preferred.

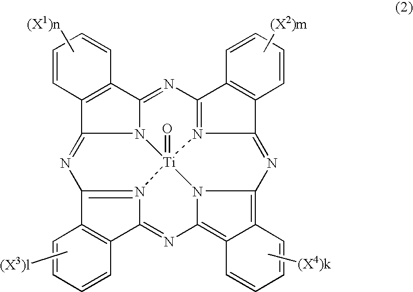

In the general formula (2), X¹, X², X³ and X⁴ each represent a hydrogen atom, a halogen atom, an alkyl group or an alkoxy group; and n, m, l and k each indicate an integer of from 1 to 4.

In the general formula (2), the halogen atom for X¹, X², X³ and X⁴ includes fluorine atom, chlorine atom, bromine atom. The alkyl group represented by X¹, X², X³ and X⁴ includes a linear alkyl group such as methyl group, ethyl group, n-propyl group, n-butyl group, n-hexyl group; a branched alkyl group such as isopropyl group, t-butyl group, neopentyl group; and a cycloalkyl group such as cyclopentyl group, cyclohexyl group, cycloheptyl group. Among these, preferred is an alkyl group having from 1 to 4 carbon atoms. The alkoxy group represented by X¹, X², X³ and X⁴ includes a linear alkoxy group such as methoxy group, ethoxy group, n-propoxy group, n-hexanoxy group; and a branched alkoxy group such as isopropoxy group, isohexanoxy group. Among these, preferred is an alkoxy group having from 1 to 4 carbon atoms.

Using a phthalocyanine compound, preferably a titanylphthalocyanine compound expressed by the general formula (2) is more effective for preventing the electric properties of the photoreceptor 1 from being worsened by the undercoat layer 12 provided between the conductive support 11 and the photosensitive layer 15 and containing an amine compound expressed by the general formula (1), and for improving the electric properties such as the chargeability, the sensitivity and the responsibility of the photoreceptor 1. Using the phthalocyanine compound, preferably the titanylphthalocyanine compound expressed by the general formula (2) as combined with an enamine compound expressed by a general formula (3) mentioned below realizes the photoreceptor 1 having further better and higher sensitivity, chargeability and image reproducibility.

The titanylphthalocyanine compounds expressed by the general formula (2) may be produced in any conventional method, for example, according to the method described by Moser & Thomas in Phthalocyanine Compounds. For example, of the titanylphthalocyanine compound expressed by the general formula (2), titanylphthalocyanine where X¹, X², X³ and X⁴ are hydrogen atoms and n, m, l and k each indicate an integer of 4 may be produced by dissolving phthalonitrile and titanium tetrachloride under heat, or reacting them in a suitable solvent such as α-chloronaphthalene to give dichlorotitanium phthalocyanine, and hydrolyzing the resulting dichlorotitanium phthalocyanine with a base or water. Apart from this, titanylphthalocyanine may also be produced by reacting isoindoline with a titanium tetraalkoxide such as titanium tetrabutoxide under heat in a suitable solvent such as N-methylpyrrolidone.

One or more such charge generating substances may be used herein either singly or as combined.

The charge generating layer 13 may contain, in addition to the pigment and dye mentioned hereinabove for the charge generating substance, various additives such as chemical sensitizer or optical sensitizer. For the chemical sensitizer, usable is an electron accepting substance, for example, a cyano compound such as tetracyanoethylene, 7,7,8,8-tetracyanoquinodimethane; a quinone compound such as anthraquinone, p-benzoquinone; or a nitro compound such as 2,4,7-trinitrofluorenone, 2,4,5,7-tetranitrofluorenone. The optical sensitizer may be dye, including, for example, xanthene dye, thiazine dye, triphenylmethane dye.

For forming the charge generating layer, employable are a vapor phase deposition method such as vacuum evaporation deposition, sputtering, chemical vapor deposition (CVD), and a coating method. The coating method may be attained as follows: a charge generating substance such as that mentioned above is ground and dispersed in a suitable solvent by the use of a ball mill, a sand grinder, a paint shaker or an ultrasonic disperser, optionally along with a binder resin added thereto to prepare a charge generating layer forming coating liquid, then the resulting coating liquid is applied onto the surface of the undercoat layer 12 according to a known coating method, and this is dried or cured to form a film thereon. according to the process, the charge generating layer 13 is formed.

The binder resin for the charge generating layer includes polyarylate, polyvinylbutyral, polycarbonate, polyester, polystyrene, polyvinyl chloride, phenoxy resin, epoxy resin, silicone resin, polyacrylate.

The solvent for the charge generating layer forming coating liquid includes alcohols such as isopropyl alcohol; ketones such as cyclohexanone, acetone, methyl ethyl ketone; hydrocarbons such as cyclohexane; aromatic hydrocarbon such as toluene, xylene; ethers such as tetrahydrofuran, dioxane, dioxolane, ethyl cellosolve, ethylene glycol dimethyl ether; esters such as ethyl acetate, methyl acetate; halogenohydrocarbons such as dichloromethane, dichloroethane, monochlorobenzene; amides such as N,N-dimethylformamide, N,N-dimethylacetamide. One or more such solvents may be used herein either singly as a single solvent, or as combined as a mixed solvent.

Of the solvents mentioned above, preferred are one or more of cyclohexanone, 1,2-dimethoxyethane, methyl ethyl ketone and tetrahydrofuran, in consideration of their properties hardly causing the reduction in the sensitivity of the photoreceptor lowing to the crystal transfer during grinding and/or milling of the charge generating substance and owing to the denaturation of the charge generating substance in the coating liquid. In this respect, the solvents hardly cause the crystal transfer and the denaturation of the charge generating substance.

When the conductive support 11 is formed in a sheet shape, then the charge generating layer forming coating liquid may be applied onto the surface of the undercoat layer 12 by the use of a baker applicator, a bar coater, a casting tool or a spin coater. On the other hand, when the conductive support 11 is cylindrical or columnar, then the charge generating layer forming coating liquid may be applied thereto according to a spraying method, a vertical ring coating method, or a dipping method.

Preferably, the thickness of the charge generating layer 13 is 0.05 μm or more and 5 μm or less, more preferably 0.1 μm or more and 1 μm or less. In case where the thickness of the charge generating layer 13 is smaller than 0.05 μm, then the light absorption efficiency of the layer may lower and the sensitivity of the photoreceptor 1 may therefore lower. On the other hand, in case where the thickness of the charge generating layer 13 is larger than 5 μm, then the charge movement inside the charge generating layer 13 may be for rate determination in the process of removing the charges from the surface of the photosensitive layer 15, and the sensitivity of the photoreceptor 1 may therefore lower.

The charge transporting layer 14 provided on the charge generating layer 13 contains a charge transporting substance and a binder resin for binding the charge transporting substance. Not specifically defined, the charge transporting substance may be any known one capable of accepting the charges generated by the charge generating substance in the charge generating layer 13 and having the ability to transport them. For example, it is an electron donating substance, including poly-N-vinylcarbazole and its derivatives, poly-g-carbazolylethyl glutamate and its derivatives, polyvinylpyrene, polyvinylphenanthrene, oxazole derivatives, oxadiazole derivatives, imidazole derivatives, 9-(p-diethylaminostyryl)anthracene, 1,1-bis(4-dibenzylaminophenyl)propane, styrylanthracene, styrylpyrazoline, pyrazoline derivatives, phenylhydrazones, hydrazone derivatives, triphenylamine compounds, tetraphenyldiamine compounds, stilbene compounds, 3-methyl-2-benzothiazoline ring-having azine compounds, enamine compounds.

Among these, preferred are enamine compounds expressed by the following general formula (3):

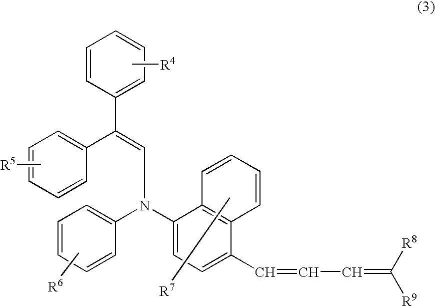

In the general formula (3), R⁴, R⁵, R⁶ and R⁷ each represents a hydrogen atom, an optionally-substituted alkoxy group, or an optionally-substituted alkyl group; R⁸ and R⁹ each represent a hydrogen atom, an optionally-substituted aryl group, or an optionally-substituted alkyl group; provided that the benzene ring and the naphthalene ring to which R⁴ to R⁷ bond may have any other substituent except R⁴ to R⁷.

In the general formula (3), the alkoxy group represented by R⁴, R⁵, R⁶ and R⁷ includes a linear alkoxy group such as methoxy group, ethoxy group, n-propoxy group; and a branched alkoxy group such as isopropoxy group. Among these, preferred is an alkoxy group having from 1 to 4 carbon atoms.

In the general formula (3), the alkyl group represented by R⁴, R⁵, R⁶, R⁷, R⁸ and R⁹ includes a linear alkyl group such as methyl group, ethyl group, n-propyl group, n-butyl group, n-hexyl group; a branched alkyl group such as isopropyl group, t-butyl group, neopentyl group; and a cycloalkyl group such as cyclopentyl group, cyclohexyl group, cycloheptyl group. Among these, preferred is an alkyl group having from 1 to 4 carbon atoms.

In the general formula (3), the aryl group represented by R⁸ and R⁹ includes a phenyl group, a naphthyl group, an anthryl group, a pyrenyl group, a biphenylyl group, a terphenyl group. Among these, preferred is a monocyclic or bicyclic aryl group such as phenyl group, naphthyl group, biphenylyl group; and more preferred is a phenyl group.

In the general formula (3), the alkoxy group, the alkyl group and the aryl group represented by R⁴ to R⁹ may be optionally substituted. The substituent for these includes an alkyl group preferably having from 1 to 4 carbon atoms, such as methyl group, ethyl group, propyl group; an alkoxy group preferably having from 1 to 4 carbon atoms, such as methoxy group, ethoxy group, propoxy group; a halogen atom such as fluorine atom, chlorine atom, bromine atom; a heterocyclic group such as thienyl group, furyl group; an aryl group such as phenyl group, naphthyl group; an aralkyl group such as benzyl group, phenethyl group; a cycloalkyl group such as cyclohexyl group.

In the general formula (3), a substituent other than R⁴ to R⁷ for the benzene ring and the naphthalene ring to which R⁴ to R⁷ bond includes a symmetric dialkylamino group such as dimethylamino group, diethylamino group, diisopropylamino group; an asymmetric dialkylamino group such as ethylmethylamino group, isopropylethylamino group, preferably a symmetric or asymmetric dialkylamino group having from 2 to 8 carbon atoms; an alkoxy group preferably having from 1 to 4 carbon atoms such as methoxy group, ethoxy group, propoxy group; an aryl group such as phenyl group, naphthyl group; and a halogen atom such as fluorine atom, chlorine atom, bromine atom.

Using the enamine compound expressed by the general formula (3) is more effective for preventing the electric properties of the photoreceptor 1 from being worsened by the undercoat layer 12 provided between the conductive support 11 and the photosensitive layer 15 and containing an amine compound expressed by the general formula (1), and for improving the electric properties such as the chargeability, the sensitivity and the responsibility of the photoreceptor 1. In particular, using the enamine compound expressed by the general formula (3) as the charge transporting substance and using the phthalocyanine compound, more preferably the titanylphthalocyanine compound expressed by the general formula (2) as the charge generating substance realizes the photoreceptor 1 having especially excellent sensitivity, chargeability and image reproducibility.

The enamine compound expressed by the general formula (3) may be produced, for example, by reacting a secondary amine compound and a carbonyl compound for dehydrating condensation to give an enamine intermediate, then introducing a carbonyl group into the intermediate through formylation by Filth-Mayer reaction or through acylation by Friedel-Crafts reaction, and further introducing a double bond part into the resulting enamine-carbonyl intermediate through Wittig-Horner reaction.

One or more such charge transporting substances may be used herein either singly or as combined.

Preferably, the content of the charge transporting substance to be in the charge transporting layer 14 is 30% by weight or more and 80% by weight or less of the total solid content of the charge transporting layer 14. In case where the content of the charge transporting substance is smaller than 30% by weight of the total solid content of the charge transporting layer 14, then there may be a possibility that the photoreceptor 1 could not have good sensitivity and responsibility enough for practical use. On the other hand, in case where the content of the charge transporting substance is larger than 80% by weight of the total solid content of the charge transporting layer 14, then the content of the binder resin to be in the layer 14 may be relatively lower and, as a result, the printing durability of the charge transporting layer 14 may lower and the mechanical durability of the photoreceptor 1 may be insufficient.

The binder resin to be in the charge transporting layer 14 so as to bind the charge transporting substance in the layer shall be compatible with the charge transporting substance. For example, it includes polycarbonate and copolymerized polycarbonate, polyarylate, polyvinylbutyral, polyamide, polyester, epoxy resin, polyurethane, polyketone, polyvinyl ketone, polystyrene, polyacrylamide, phenolic resin, phenoxy resin, polysulfone resin, and their copolymerized resins. Among these, preferred are polystyrene, polycarbonate, copolymerized polycarbonate, polyarylate and polyester, since their volume resistivity is at least 10¹³ Ω and their electric insulating property is good and since they have good film forming capability and good potential characteristics. One or more such binder resins may be used herein either singly or as combined.

The charge transporting layer 14 may contain various additives such as chemical sensitizer or optical sensitizer, in addition to the charge transporting substance and the binder resin therein. Adding a chemical sensitizer or an optical sensitizer to the charge transporting layer 14 is effective for improving the sensitivity of the photoreceptor 1 and for inhibiting the residual potential increase and the fatigue deterioration of the photoreceptor 1 in repeated use. The chemical sensitizer may be an electron accepting substance, including, for example, acid anhydrides such as succinic anhydride, maleic anhydride, phthalic anhydride, 4-chloronaphthalic anhydride; cyano compounds such as tetracyanoethylene, terephthalmalondinitrile; aldehydes such as 4-nitrobenzaldehyde; anthraquinones such as anthraquinone, 1-nitroanthraquinone; polycyclic or heterocyclic nitro compounds such as 2,4,7-trinitrofluorenone, 2,4,5,7-tetranitrofluorenone. The optical sensitizer includes, for example, dyes such as xanthene dye, thiazine dye, triphenylmethane dye; and other organic photoconductive compounds such as quinoline pigment, copper phthalocyanine.

The charge transporting layer 14 may be formed in the same manner as that for forming the charge generating layer 13. For example, a charge transporting substance and a binder resin such as those mentioned above and optionally various additives such as chemical sensitizer and optical sensitizer also mentioned above are dissolved and/or dispersed in a suitable solvent to prepare a charge transporting layer forming coating liquid, and the coating liquid is applied onto the surface of the charge generating layer 13, and dried thereon to form the intended charge transporting layer 14.

The solvent for the charge generating layer forming coating liquid includes alcohols such as methanol, ethanol; ketones such as acetone, methyl ethyl ketone, cyclohexanone; ethers such as ethyl ether, tetrahydrofuran, dioxane, dioxolane; aliphatic halogenohydrocarbons such as chloroform, dichloromethane, dichloroethane; and aromatic hydrocarbons such as benzene, chlorobenzene, toluene. One or more such solvents may be used herein either singly or as combined.

Preferably, the thickness of the charge transporting layer 14 is 10 μm or more and 50 μm or less, more preferably 15 μm or more and 40 μm or less. In case where the thickness of the thickness of the charge transporting layer 14 is smaller than 10 μm, then the charge retentive capability of the surface of the photoreceptor 1 may lower. On the other hand, in case where the thickness of the charge transporting layer 14 is larger than 50 μm, then the resolution of the photoreceptor 1 may lower.

The photoreceptor 15 comprises a laminated structure of the charge generating layer 13 and the charge transporting layer 14. Since the two different layers individually have the charge generating function and the charge transporting function in this embodiment, the most suitable materials may be selected for the charge generating layer and the charge transporting layer and the photoreceptor 1 may therefore have especially excellent sensitivity, chargeability and image reproducibility.

The mechanism of the photoreceptor 1 of forming an electrostatic latent image thereon is described briefly hereinunder. The photosensitive layer 15 provided on the photoreceptor 1 is, for example, uniformly negatively charged by a charger. When the thus charged photoreceptor 1 is exposed to light that may be absorbed by the charge generating layer 13, then electron and hole charges are generated in the charge generating layer 13. The holes are transported to the surface of the photoreceptor 1 by the charge transporting substance in the charge transporting layer 14 to thereby neutralize the negative charges on the surface of the photoreceptor 1, while the electrons in the charge generating layer 13 move toward the conductive support 11 in which positive charges have been induced and neutralize the positive charges. In that manner, there occurs a difference between the charged amount in the exposed area and the charged amount in the non-exposed area, and an electrostatic latent image is therefore formed on the photosensitive layer 15.

As mentioned hereinabove, in this embodiment, the photosensitive layer 15 comprises the charge generating layer 13 and the charge transporting layer 14 laminated in that order on the undercoat layer 12. The photosensitive layer 15 is not limited to the structure as above. For example, the charge transporting layer 14 and the charge generating layer 13 may be laminated in that order on the undercoat layer 12 to constitute the photosensitive layer 15.

FIG. 2 is a partial cross-sectional view schematically showing the constitution of an electrophotographic photoreceptor 2 according to a second embodiment of the invention. The photoreceptor 2 of this embodiment is similar to the photoreceptor 1 according to the first embodiment of FIG. 1, and the same or corresponding parts in the two are represented by the same reference numerals and their description is omitted hereinunder. The photoreceptor 2 is characterized in that a single layered photosensitive layer 16 containing both a charge generating substance and a charge transporting substance is provided on the undercoat layer 12. Accordingly, the photoreceptor 2 of this embodiment is a single layered photoreceptor.

The single layered photoreceptor 2 of this embodiment is favorable as a photoreceptor for positively charging image forming apparatus with little ozone generation. Since the single layered photoreceptor 2 of this embodiment has only one layer of the photosensitive layer 16 to be formed on the undercoat layer 12, its production costs are low and its producibility is high as compared with the laminate structured photoreceptor 1 of the first embodiment where the charge generating layer 13 and the charge transporting layer 14 are laminated on the undercoat layer 12.

Also in this embodiment, the undercoat layer 12 contains an amine compound expressed by the general formula (1). Accordingly, the photoreceptor 2 of this embodiment has good electric properties such as chargeability, sensitivity and responsibility, has good oxidizing gas resistance, and has good property stability in that the good electric properties thereof do not worsen in repeated use and are enough for practical use even after repeated use, like the photoreceptor 1 of the first embodiment.

The photosensitive layer 16 comprises a charge generating substance and a charge transporting substance such as those mentioned above, dispersed in a binder resin. Using the same charge generating substance, the same charge transporting substance and the same binder as in the photoreceptor 1 of the first embodiment, the photosensitive layer 16 may be formed in the same manner as that for forming the charge generating layer 13 or the charge transporting layer 14 in the first embodiment. For example, a charge generating substance and a charge transporting substance are dispersed in a solution of a binder resin or pigment particles of a charge generating substance are dispersed in a binder resin that contains a charge transporting substance to thereby prepare a photosensitive layer forming coating liquid, and the coating liquid is applied onto the surface of the undercoat layer 12 and dried thereon in the same manner as that for forming the charge generating layer 13 in the first embodiment, thereby forming the intended, single layered photosensitive layer 16.

The mechanism of the photoreceptor 2 of forming an electrostatic latent image thereon is described briefly hereinunder. The photosensitive layer 16 provided on the photoreceptor 2 is, for example, uniformly positively charged by a charger. When the thus charged photoreceptor 2 is exposed to light that may be absorbed by the charge generating substance in the layer 16, then electron and hole charges are generated near the surface of the photosensitive layer 16. The electrons neutralize the positive charges on the surface of the photosensitive layer 16, while the holes are transported toward the conductive support 11 on which negative charges have been induced, by the charge transporting substance in the layer 16 to thereby neutralize the negative charges induced on the conductive support 11. In that manner, there occurs a difference between the charged amount in the exposed area and the charged amount in the non-exposed area, and an electrostatic latent image is therefore formed on the photosensitive layer 16.

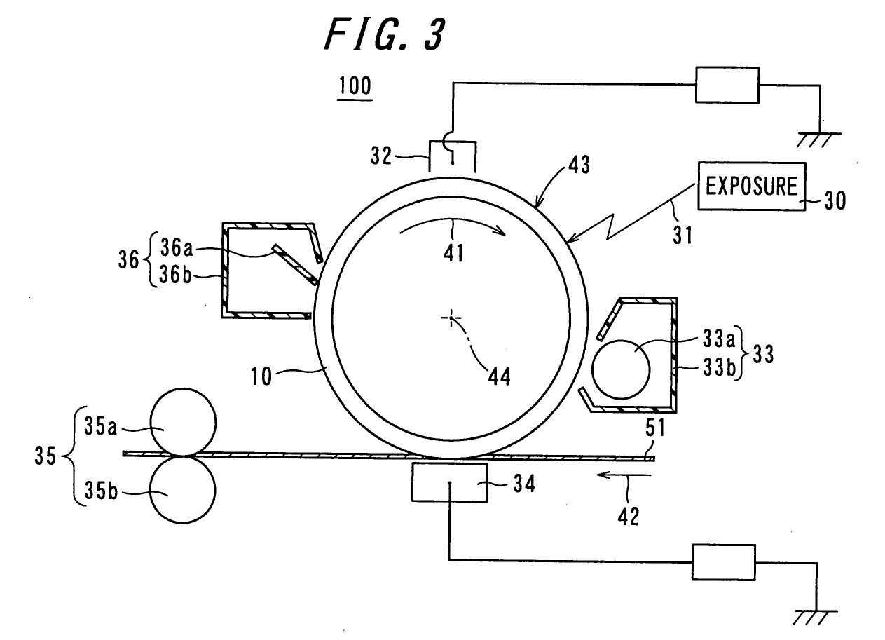

The image forming apparatus of the invention that comprises the electrophotographic photoreceptor of the invention is described below. FIG. 3 is an arrangement side view graphically showing the constitution of an image forming apparatus 100 according to a third embodiment of the invention. The image forming apparatus 100 of FIG. 3 comprises, mounted thereon, a cylindrical electrophotographic photoreceptor 10 having the same layer constitution as that of the photoreceptor 1 of the first embodiemnt of FIG. 1. The constitution of the image forming apparatus 100 and the mechanism thereof of image formation are described hereinunder with reference to FIG. 3.

The image forming apparatus 100 comprises the photoreceptor 10 rotatably supported by the apparatus body (not shown), and a driving unit (not shown) for rotating and driving the photoreceptor 10 in the direction of the arrow 41 around the rotation axis line 44 of the photoreceptor 10. The driving unit comprises, for example, a motor as a power source, and the power from the motor is transmitted to the support that constitute the core of the photoreceptor 10, via a gear (not shown), whereby the photoreceptor 10 is rotated and driven at a predetermined peripheral speed.

Around the photoreceptor 10, provided are a charger 32, exposure means 30, a developing unit 33, a transfer unit 34 and a cleaner 36 in that order from the upstream side to the downstream side in a rotating direction of the photoreceptor 10 as indicated by the arrow 41. The cleaner 36 is arranged along with a discharging lamp (not shown).

The charger 32 is charging means for charging the surface 43 of the photoreceptor 10 in a predetermined negative or positive potential level. The charger 32 is, for example, non-contact charging means such as a corona-discharge charger.

The exposure means 30 is provided with, for example, a semiconductor laser as its light source, and it acts as follows: the surface 43 of the charged photoreceptor 10 is exposed to the light 31 such as the laser beam outputted from the light source in accordance with the image information, and an electrostatic latent image is thereby formed on the surface 43 of the photoreceptor 10.

The developing unit 33 is developing means for developing the electrostatic latent image formed on the surface 43 of the photoreceptor 10, by a developer to thereby form a visible image that is a toner image. The developing unit 33 comprises a developing roller 33a disposed to face the photoreceptor 10 so as to supply toner to the surface 43 of the photoreceptor 10, and a casing 33b that supports the developing roller 33a rotatably around the rotation axis line thereof parallel to the rotation axis line 44 of the photoreceptor 10 and stores a toner containing developer inside its inner space.

The transfer unit 34 is transfer means for transferring the toner image formed on the surface 43 of the photoreceptor 10, onto a transfer material that is recording paper 51, from the surface 43 of the photoreceptor 10. The transfer unit 34 is provided with charging means such as, for example, a corona-discharge charger, and it is non-contact transfer means that imparts charges with reversed polarity to toner, to the recording paper 51 to thereby transfer the toner image onto the recording paper 51.

The cleaner 36 is cleaning means for cleaning the surface 43 of the photoreceptor 10 from which the toner image has been transferred. The cleaner 36 comprises a cleaning blade 36a that is pressed against the photoreceptor surface 43 to thereby peel away the impurities such as the toner and the paper powder remaining on the surface 43 of the photoreceptor 10, from the surface 43 after the image transfer therefrom, and a collection casing 36b for keeping therein the impurities peeled away by the cleaning blade 36a. All the toner having formed a toner image on the surface 43 of the photoreceptor 10 is not always transferred onto the recording paper 51, but a little of it may remain on the surface 43 of the photoreceptor 10. The toner thus remaining on the photoreceptor surface 43 is referred to as “residual toner”, and the presence of the residual toner may worsen the quality of the image formed. Therefore, the residual toner is removed and cleaned off from the surface 43 of the photoreceptor 10 by the cleaning blade 36a pressed against the photoreceptor surface 43, along with other impurities such as paper powder.

A fixing unit 35, which is fixing means for fixing the transferred toner image on the recording paper 51, is provided, spaced from the photoreceptor 10 in the direction in which the recording paper 51 is conveyed after having passed between the photoreceptor 10 and the transfer unit 34. The fixing unit 35 comprises a hot roller 35a provided with a heating unit (not shown), and a pressure roller 35b disposed opposite to the hot roller 35a and pressed against the hot roller 35a to form a contact area between the two.

The mechanism of image formation by the image forming apparatus 100 is described. In accordance with the instruction from a control unit (not shown), the photoreceptor 10 is rotated and driven by a driving unit in the direction of the arrow 41, and its surface 43 is then uniformly charged at a predetermined negative or positive level by the charger 32 disposed on the upstream side in the rotation direction of the photoreceptor 10 with respect to the point of image formation with the light 31 from the exposing unit 30.

Next, the surface 43 of the charged photoreceptor 10 is irradiated with light 31 from the exposing unit 30 in accordance with the instruction from the control unit. On the basis of the image information thereto, the photoreceptor 10 is repeatedly scanned in the main scanning direction that is the lengthwise direction thereof, with the light 31 from the light source. The photoreceptor 10 is rotated and driven, and is repeatedly scanned with the light 31 from the light source on the basis of the image information thereto, and the surface 43 of the photoreceptor 10 is thereby exposed to light in accordance with the image information thereto. Through the exposure, the surface charges in the area to which has been irradiated with the light 31 decrease, and there occurs a difference in the surface potential between the area exposed to the light 31 and that not exposed to the light 31, and, as a result, an electrostatic latent image is thereby formed on the surface 43 of the photoreceptor 10. Synchronized with the exposure of the photoreceptor 10 to light, recording paper 51 is conveyed in the direction of the arrow 42 by a conveyor unit (not shown) to the transfer position between the transfer unit 34 and the photoreceptor 10.

Next, toner is supplied to the surface 43 of the photoreceptor 10 with the electrostatic latent image formed thereon, from the developing roller 33a of the developing unit 33 disposed on the downstream side in the rotation direction of the photoreceptor 10 with respect to the point of image formation with the light 31 from the light source. With that, the electrostatic latent image is thereby developed to form a visible toner image on the surface 43 of the photoreceptor 10. When the recording paper 51 reaches between the photoreceptor 10 and the transfer unit 34, then charges of reversed polarity to toner are given to the recording paper 51 by the transfer unit 34 whereby the toner image formed on the surface 43 of the photoreceptor 10 is transferred onto the recording paper 51.

The recording paper 51 with the toner image transferred thereon is conveyed to the fixing unit 35 by conveying means, and while it passes through the contact area between the hot roller 35a and the pressure roller 35b, it is heated and pressed. Accordingly, the toner image on the recording paper 51 is fixed thereon to be a fastened image thereon. The recording paper 51 with the image formed in that manner thereon is led out of the image forming apparatus 100 by the conveyor means.

On the other hand, after the toner image has been transferred onto the recording paper 51, the photoreceptor 10 further rotates in the direction of the arrow 41 and its surface 43 is rubbed with the cleaning blade 36a of the cleaner 36 and is thereby cleaned. The surface 43 of the photoreceptor 10 from which the impurities such as toner have been removed in that manner is discharged by the light from a discharging lamp. As a result, the electrostatic latent image on the surface 43 of the photoreceptor 10 disappears. Next, the photoreceptor 10 is further rotated and driven, and the same process as above starting from the step of charging the photoreceptor 10 is again repeated. Through the process, an image is continuously formed.

In the photoreceptor 10 provided in the image forming apparatus 100, an amine compound expressed by the general formula (1) is contained in the undercoat layer, and the photoreceptor 10 has good electric properties such as chargeability, sensitivity and responsibility and has good oxidizing gas resistance, therefore having the advantage in that it is hardly influenced by the oxidizing gas such as ozone and nitrogen oxide generated by the charger 32 such as corona-discharge charger. Accordingly, the photoreceptor 10 does not detract from its good electric properties as above even in repeated use, therefore keeping good electric properties enough for practical use even after repeated use. To that effect, it realizes the image forming apparatus 100 of good durability capable of stable forming high quality images of high resolution with no image defects for a long period of time.

As described hereinabove, the photoreceptor 10 provided in the image forming apparatus 100 of this embodiment has the same layer constitution as that of the photoreceptor 1 of the first embodiment of FIG. 1. Not limited to the constitution, however, the photoreceptor 10 may have any other constitution, for example, the same layer constitution as that of the photoreceptor 2 of the second embodiment of FIG. 2.

The image forming apparatus of the invention is not limited to the constitution of the image forming apparatus 100 of FIG. 3 described hereinabove, but may have any other constitution in which the photoreceptor of the invention can be used.

For example, in the image forming apparatus 100 of this embodiment, the charger 32 is the non-contact charging means, to which, however, the charger 32 is not limited. For example, the charger may be contact charging means such as charging roller. The transfer unit 34 is the non-contact transfer means not requiring transfer pressure, to which, however, the transfer unit is not limited but may be contact transfer means requiring transfer pressure. For example, one example of the contact transfer means comprises a transfer roller, wherein the transfer roller is pressed against the photoreceptor 10 on the surface opposite to the surface of the contact area between the recording paper 51 and the surface 43 of the photoreceptor 10, and while the photoreceptor 10 is kept pressed against the recording paper 51, a voltage is applied to the transfer roller so as to transfer the toner image onto the recording paper 51.

### EXAMPLES

The invention is described in more detail with reference to the following Examples and Comparative Examples, to which, however, the invention is not limited.

### Production Examples

In the following Examples and Comparative Examples, an enamine compound expressed by the following structural formula (3a) was used as the charge transporting substance.

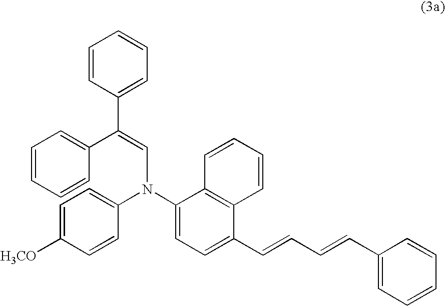

A method for producing the enamine compound expressed by the structural formula (3a) is described below.

[Production of Enamine Compound Expressed by Structural Formula (3a)]

### Production Example 1-1

### Production of Enamine Intermediate

4.9 g (1.0 molar equivalent) of N-(p-methoxyphenyl)-α-naphthylamine expressed by the following structural formula (4), 4.1 g (1.05 molar equivalents) of diphenylacetaldehyde expressed by the following structural formula (5), and 46 mg (0.01 molar equivalents) of DL-10-camphorsulfonic acid were added to 100 ml of toluene and heated, and this was reacted for 6 hours while water produced as a side product was removed out of the system azeotropically with toluene. After the reaction, the reaction solution was concentrated to about 1/10, and gradually and dropwise added to 100 ml of hexane stirred vigorously to thereby form a crystal. The crystal thus formed was taken out through filtration, and washed with cold ethanol to obtain 7.9 g of a pale yellow powdery compound.

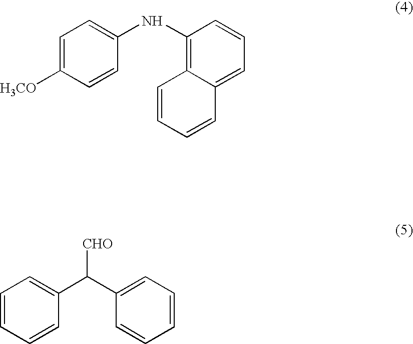

The resulting compound was analyzed through liquid chromatography-mass spectrometry (LC-MS), which gave a peak at 428.5 corresponding to a molecular ion [M+H]⁺ of an enamine intermediate (calculated value of molecular weight: 427.20) expressed by the following structural formula (6), with a proton added thereto. This confirms that the compound obtained herein is the enamine intermediate expressed by the structural formula (6) (yield: 94%). The result of LC-MS analysis further confirmed that the purity of the enamine intermediate obtained herein is 94%.

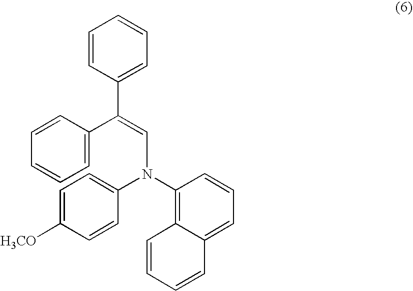

As in the above, the dehydrating condensation of a secondary amine compound, N-(p-methoxyphenyl)-α-naphthylamine expressed by the structural formula (4) with an aldehyde compound, diphenylacetaldehyde expressed by the structural formula (5) gave a high yield of the enamine intermediate expressed by the structural formula (6).

### Production Example 1-2

### Production of Enamine-Aldehyde Intermediate

3.4 g (1.2 molar equivalents) of phosphorus oxychloride was gradually added to 100 ml of anhydrous N,N-dimethylformamide (DMF) with cooling with ice, and stirred for about 30 minutes to prepare a Filth-Mayer reagent. With cooling with ice, 7.9 g (1.0 molar equivalent) of the enamine intermediate expressed by the structural formula (6) obtained in Production Example 1-1 was gradually added to the solution. Next, this was gradually heated so as to elevate the reaction temperature up to 80° C., and this was stirred for 3 hours while still heated and kept at 80° C. After the reaction, the reaction solution was left cooled, and gradually added to 800 ml of a cooled, aqueous 4 N sodium hydroxide solution to form a precipitate. The resulting precipitate was taken out through filtration, fully washed with water, and recrystallized from a mixed solvent of ethanol and ethyl acetate to obtain 7.2 g of an yellow powdery compound.

The resulting compound was analyzed through LC-MS, which gave a peak at 456.5 corresponding to a molecular ion [M+H]⁺ of an enamine-aldehyde intermediate (calculated value of molecular weight: 455.19) expressed by the following structural formula (7), with a proton added thereto. This confirms that the compound obtained herein is the enamine-aldehyde intermediate expressed by the structural formula (7) (yield: 85%). The result of LC-MS analysis further confirmed that the purity of the enamine-aldehyde intermediate obtained herein is 85%.

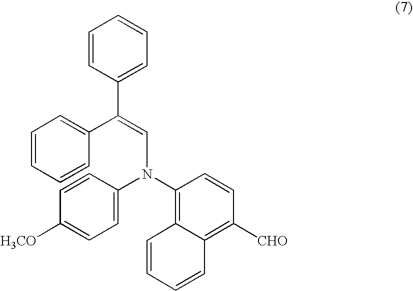

As in the above, the formylation of the enamine intermediate expressed by the structural formula (6) through Filth-Mayer reaction gave a high yield of the enamine-aldehyde intermediate expressed by the structural formula (7).

### Production Example 1-3

### Production of Enamine Compound Expressed by Structural Formula (3a)

7.0 g (1.0 molar equivalent) of the enamine-aldehyde intermediate expressed by the structural formula (7) obtained in Production Example 1-2, and 4.7 g (1.2 molar equivalents) of diethyl cinnamylphosphate expressed by the following structural formula (8) were dissolved in 80 ml of anhydrous DMF, and 2.15 g (1.25 molar equivalents) of potassium t-butoxide was gradually added to the resulting solution at room temperature and heated up to 50° C. Still heated and kept at 50° C., this was stirred for 5 hours. The reaction mixture was left cooled, and poured into excess methanol. The resulting precipitate was collected, and dissolved in toluene to prepare a toluene solution. The toluene solution was transferred into a separating funnel and washed with water, and the organic layer was taken out and dried with magnesium sulfate. After thus dried, a solid was removed from the organic layer, and the organic layer was then concentrated and subjected to silica gel column chromatography to obtain 7.9 g of an yellow crystal.

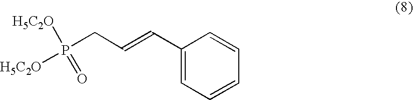

The resulting crystal was analyzed through LC-MS, which gave a peak at 556.7 corresponding to a molecular ion [M+H]⁺ of an enamine compound (calculated value of molecular weight: 555.26) expressed by the structural formula (3a), with a proton added thereto. The nuclear magnetic resonance (NMR) spectrum of the crystal in heavy chloroform (chemical formula: CDCl₃) supported the structure of the enamine compound expressed by the structural formula (3a). The result of LC-MS analysis and the result of NMR spectrometry confirmed that the crystal obtained herein is the enamine compound expressed by the structural formula (3a) (yield: 92%). The result of LC-MS analysis further confirmed that the purity of the enamine compound expressed by the structural formula (3a) obtained herein is 99%.

As in the above, the Wittig-Horner reaction of the enamine-aldehyde intermediate expressed by the structural formula (7) with a Wittig reagent, diethyl cinnamylphosphate expressed by the structural formula (8) gave a high yield of the enamine compound expressed by the structural formula (3a)

### EXAMPLES

A photosensitive layer and an undercoat layer were formed on an aluminium cylindrical conductive support having an outer diameter of 30 mm and a length of 346 mm under various conditions to thereby fabricate various photoreceptors of Examples and Comparative Examples. In the following description, two different types of photoreceptors were fabricated under various conditions, of which one is for testing its oxidizing gas resistance in a test device mentioned hereinunder (this is hereinafter referred to as “photoreceptor for test in test device”), and the other is for testing its oxidizing gas resistance in a practical device (this is hereinafter referred to as “photoreceptor for test in practical device”).

### Example 1

### Fabrication of Photoreceptor for Test in Test Device

3 parts by weight of titanium oxide (trade name: TTO-D1 (dendritic rutile-type surface-treated with Al₂O₃ and ZrO₂, titanium component 85%), by Ishihara Sangyo), 3 parts by weight of alcohol-soluble nylon resin (trade name: CM8000 by Toray), and 0.3 parts by weight (corresponding to 4.8% by weight of the total solid content of undercoat layer) of tribenzylamine (amine compound No. 1 in Table 1) were added to a mixed solvent of 60 parts by weight of methanol and 40 parts by weight of 1,3-dioxolane, and dispersed in a paint shaker for 10 hours to prepare an undercoat layer forming coating liquid. The coating liquid was filled in a coating tank, a conductive support was dipped in it and then pulled out of it, and then left dried to form an undercoat layer having a thickness of 0.9 μm.

Next, 10 parts by weight of polyvinylbutyral resin (trade name: S-LEC BL-2, by Sekisui Chemical Industry), 1400 parts by weight of 1,3-dioxolane, and 15 parts by weight of titanylphthalocyanine (in the general formula (2) where X¹, X², X³ and X⁴ are hydrogen atoms and n, m, l and k each indicate an integer of 4) were dispersed in a ball mill for 72 hours to prepare a charge generating layer forming coating liquid. The coating liquid was applied onto the undercoat layer according to the same dipping method as that for the undercoat layer, and then left dried to form a charge generating layer having a thickness of 0.2 μm.

Next, 100 parts by weight of a charge transporting substance, the enamine compound expressed by the structural formula (3a) produced in the Production Example, and 48 parts by weight, 32 parts by weight, 32 parts by weight or 48 parts by weight of a binder resin, polycarbonate resin J-500, G-400, GH-503 (tradenames, these three are by Idemitsu Kosan) or TS2020 (trade name by Teijin Chemical) were mixed, and dissolved in 980 parts by weight of tetrahydrofuran to prepare a charge transporting layer forming coating liquid. The coating liquid was applied onto the charge generating layer according to the same dipping method as that for the undercoat layer and then dried at 130° C. for 1 hour to form a charge transporting layer having a thickness of 15 μm. The process gave a photoreceptor Example 1 for test in test device.

[Fabrication of Photoreceptor for Test in Practical Device]

A photoreceptor of Example 1 for test in practical device was fabricated in the same manner as that for the photoreceptor for test in test device, in which, however, the thickness of the charge transporting layer was 28 μm.

### Example 2

A photoreceptor for test in test device and a photoreceptor for test in practical device of Example 2 were fabricated in the same manner as in Example 1, in which, however, the amount of the amine compound No. 1 used in forming the undercoat layer was 0.7 parts by weight (corresponding to 10% by weight of the total solid content of the undercoat layer)

### Example 3

A photoreceptor for test in test device and a photoreceptor for test in practical device of Example 3 were fabricated in the same manner as in Example 1, in which, however, the amount of the amine compound No. 1 used in forming the undercoat layer was 0.9 parts by weight (corresponding to 13% by weight of the total solid content of the undercoat layer)

### Example 4

A photoreceptor for test in test device and a photoreceptor for test in practical device of Example 4 were fabricated in the same manner as in Example 1, in which, however, the amount of the amine compound No. 1 used in forming the undercoat layer was 0.006 parts by weight (corresponding to 0.1% by weight of the total solid content of the undercoat layer)

### Example 5

A photoreceptor for test in test device and a photoreceptor for test in practical device of Example 5 were fabricated in the same manner as in Example 1, in which, however, the phenylamine structure-having amine compound of No. 2 in Table 1 was used in place of the amine compound of No. 1 in forming the undercoat layer.

### Example 6

A photoreceptor for test in test device and a photoreceptor for test in practical device of Example 6 were fabricated in the same manner as in Example 1, in which, however, the diaralkylamine structure-having amine compound of No. 3 in Table 1 was used in place of the amine compound of No. 1 in forming the undercoat layer.

### Example 7

A photoreceptor for test in test device and a photoreceptor for test in practical device of Example 7 were fabricated in the same manner as in Example 1, in which, however, triphenetylamine which is the amine compound of No. 4 in Table 1 was used in place of the amine compound of No. 1 in forming the undercoat layer.

### Example 8

A photoreceptor for test in test device and a photoreceptor for test in practical device of Example 8 were fabricated in the same manner as in Example 1, in which, however, the aralkylamine-arylamine structure-having amine compound of No. 5 in Table 1 was used in place of the amine compound of No. 1 in forming the undercoat layer.

### Example 9

A photoreceptor for test in test device and a photoreceptor for test in practical device of Example 9 were fabricated in the same manner as in Example 1, in which, however, the diaralkylamine-arylamine structure-having amine compound of No. 6 in Table 1 was used in place of the amine compound of No. 1 in forming the undercoat layer.

### Example 10

A photoreceptor for test in test device and a photoreceptor for test in practical device of Example 10 were fabricated in the same manner as in Example 1, in which, however, the diaralkylamine structure-having amine compound of No. 7 in Table 1 was used in place of the amine compound of No. 1 in forming the undercoat layer.

### Example 11

A photoreceptor for test in test device and a photoreceptor for test in practical device of Example 11 were fabricated in the same manner as in Example 1, in which, however, the diaralkylamine structure-having amine compound of No. 8 in Table 1 was used in place of the amine compound of No. 1 in forming the undercoat layer.

### Example 12

A photoreceptor for test in test device and a photoreceptor for test in practical device of Example 12 were fabricated in the same manner as in Example 1, in which, however, the amount of the amine compound No. 1 used in forming the undercoat layer was 2.8 parts by weight (corresponding to 32% by weight of the total solid content of the undercoat layer)

### Example 13

A photoreceptor for test in test device and a photoreceptor for test in practical device of Example 13 were fabricated in the same manner as in Example 1, in which, however, the amount of the amine compound No. 1 used in forming the undercoat layer was 0.0048 parts by weight (corresponding to 0.08% by weight of the total solid content of the undercoat layer).

### Comparative Example 1

A photoreceptor for test in test device and a photoreceptor for test in practical device of Comparative Example 1 were fabricated in the same manner as in Example 1, in which, however, the amine compound No. 1 was not used in forming the undercoat layer.

### Comparative Example 2

A photoreceptor for test in test device and a photoreceptor for test in practical device of Comparative Example 2 were fabricated in the same manner as in Example 1, in which, however, the amine compound No. 1 was not used in forming the undercoat layer but 5 parts by weight of the amine compound No. 1 was added to the charge transporting layer forming coating liquid in forming the charge transporting layer.

### Comparative Example 3

A photoreceptor for test in test device and a photoreceptor for test in practical device of Comparative Example 3 were fabricated in the same manner as in Example 1, in which, however, the amine compound No. 1 was not used in forming the undercoat layer but 7.5 parts by weight of the amine compound No. 1 was added to the charge generating layer forming coating liquid in forming the charge generating layer.

### Comparative Example 4

A photoreceptor for test in test device and a photoreceptor for test in practical device of Comparative Example 4 were fabricated in the same manner as in Example 1, in which, however, the amine compound No. 1 was not used in forming the undercoat layer but 5 parts by weight of a hindered phenol-type antioxidant, Sumilizer BHT (trade name by Sumitomo Chemical Industry) was added to the charge transporting layer forming coating liquid in forming the charge transporting layer.

### Comparative Example 5

A photoreceptor for test in test device and a photoreceptor for test in practical device of Comparative Example 5 were fabricated in the same manner as in Example 1, in which, however, a hindered amine-type antioxidant expressed by the following structural formula (9) was used in place of the amine compound No. 1 in forming the undercoat layer.

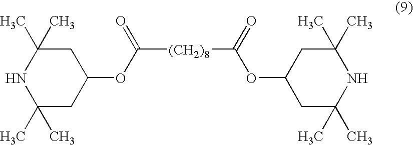

The photoreceptors of Examples 1 to 13 and Comparative Examples 1 to 5 fabricated in the manner as above were tested for (a) the oxidizing gas resistance and (b) the stability of electric properties thereof, and for (c) the overall capability of each photoreceptor.

(a) Oxidizing Gas Resistance

[Test in Test Device]

The photoreceptor for test in test device (thickness of charge transporting layer: 15 μm) of Examples 1 to 13 and Comparative Examples 1 to 5 was mounted on a test copier, and its surface potential V₁ (V) just after charged, and V₂ (V) after 3 seconds after the charging were measured in a normal temperature/normal humidity (N/N) condition at 25° C. and 50% RH. The test copier was a modification of a commercially-available copier AR-F330 (trade name by Sharp) equipped with a corona-discharge charger for charging the photoreceptor, in which a surface potentiometer (trade name: CATE751 by Gentec) was disposed so as to measure the surface potential of the photoreceptor in the process of image formation thereon. Thus measured, the surface potential V₁ (V) just after charged and V₂ (V) after 3 seconds after the charging were applied to the following formula (I), and the charge retentiveness DD (%) was obtained. This is the initial charge retentiveness DD₀.
Charge Retentiveness DD (%)=[V₂(V)/V₁(V)]×100.

Next, using an ozone generation/control device (trade name: OES-10A by Dylec), each photoreceptor was exposed to ozone for 20 hours in a closed container in which the ozone concentration was controlled to about 7.5 ppm (as confirmed by Dylec's ozone detector MODEL 1200 (trade name)). After exposure to ozone, each photoreceptor was left for 2 hours in a normal temperature/normal humidity (N/N) condition at 25° C. and 50% RH, and then its charge retentiveness DD (%) was obtained in the same manner as that before exposure to ozone. This is the charge retentiveness after exposure to ozone DD₀₂.

The value obtained by subtracting the charge retentiveness after exposure to ozone DD₀₂ from the charge retentiveness before exposure to ozone, or that is the initial charge retentiveness DD₀ is obtained, and this is a charge retentiveness variation, ΔDD (=DD₀−DD₀₂). This is an index of the oxidizing gas resistance of the photoreceptor tested.

[Test in Practical Test]

The photoreceptor for test in practical device (thickness of charge transporting layer: 28 μm) of Examples 1 to 13 and Comparative Examples 1 to 5 was mounted on a commercially-available copier AR-F330 (trade name by Sharp) equipped with a corona-discharge charger for charging the photoreceptor, and a test image of a predetermined pattern was copied on 50,000 sheets of recording paper in a normal temperature/normal pressure (N/N) condition at 25° C. and 50% RH. After the end of the copying operation to give 50,000 copies, the copier was stopped for 1 hour, and then a halftone image was copied on recording paper. This is the first test image. Next, the test image of a predetermined pattern was again copied on 50,000 sheets of recording paper in an N/N condition at 25° C. and 50% RH. After the end of the copying operation to give 50,000 copies, the copier was stopped for 1 hour, and then a halftone image was copied on recording paper. This is the second test image.

The first test image and the second test image were visually checked for their image quality. Concretely, the image area in the recording paper in which the toner image was transferred from the site of the photoreceptor that had been disposed adjacent to the corona-discharge charger when the copier was stopped was checked for image defects such as white spots and black streaks seen therein, and the degree of image defects is an index for the oxidizing gas resistance of the photoreceptor tested. The image quality was evaluated as follows:
A: Excellent. No image defects seen in both the first test image and the second test image;
B: Good. Some but negligible image defects seen in either one of or both the first test image and the second test image;
C: Average. Some image defects seen in either one of or both the first test image and the second test image, but with no problem in practical use; and
D: Not good. Many image defects seen in either one of or both the first test image and the second test image, and improper for practical use.

The charge retentiveness variation ADD and the image quality test were combined, and the oxidizing gas resistance of the photoreceptor was evaluated. The standard for evaluating the oxidizing gas resistance is as follows:
A: Excellent. ADD is less than 3.0%, and the image quality is excellent (A);
B: Good. ADD is 3.0% or more and less than 7.0%, and the image quality is excellent (A); or ADD is less than 7.0%, and the image quality is good (B);
C: Average with no problem in practical use. ADD is less than 7.0%, and the image quality is average (C); and
D: Not good. ADD is 7.0% or more, or the image quality is not good (D).

(b) Stability of Electric Properties:

The photoreceptor for test in practical device (thickness of charge transporting layer: 28 μm) of Examples 1 to 13 and Comparative Examples 1 to 5 was mounted on a test copier, and the stability of its electric properties was evaluated under a low temperature/low humidity (L/L) condition at 5° C. and 20% RH and under a high temperature/high humidity (H/H) condition at 35° C. and 85% RH, in the manner mentioned below. The test copier was a modification of a commercially-available copier AR-F330 (trade name by Sharp) equipped with a corona-discharge charger for charging the photoreceptor, in which a surface potentiometer (trade name: CATE751 by Gentec) was disposed so as to measure the surface potential of the photoreceptor in the process of image formation thereon. The copier AR-F330 is a negative charging image forming apparatus in which the surface of the photoreceptor is negatively charged.

Using a test copier with the photoreceptor of Examples 1 to 13 and Comparative Examples 1 to 5 mounted thereon, the surface potential of the photoreceptor just after charged with a charger was measured as the charge potential V0 (V). This is the initial charge potential V0₁. Immediately after exposed to laser light, the surface potential of the photoreceptor was measured as the residual potential Vr (V). This is the initial residual potential Vr₁.

Next, a test image of a predetermined pattern was copied on 300,000 sheets of recording paper, and the charge potential V0 and the residual potential Vr were measured in the same manner as that for the initial determination. These are the charge potential after repeated use V0₂, and the residual potential after repeated use Vr₂. The absolute value of the difference between the initial charge potential V0₁ and the charge potential after repeated use V0₂ is obtained as a charge potential variation ΔV0 (=V0₁−V0₂₁). The absolute value of the difference between the initial residual potential Vr₁ and the residual potential after repeated use Vr₂ is obtained as a residual potential variation ΔVr (=|Vr₁−Vr₂|). Based on the charge potential variation ΔV0 and the residual potential variation ΔVr as the evaluation indices, the stability of the electric properties of the photoreceptor tested was evaluated.

The evaluation standard for the stability of electric properties in L/L condition is as follows:
A: Excellent. ΔV0 is at most 35 V, and ΔVr is at most 55 V;
B: Good. ΔV0 is at most 35 V, and ΔVr is more than 55 V but at most 80 V; or ΔV0 is more than 35 V but at most 75 V, and ΔVr is at most 55 V;
C: Average with no problem in practical use. ΔV0 is more than 35 V but at most 75 V, and ΔVr is more than 55 V but at most 80 V; and
D: Not good. ΔV0 is more than 75 V, or ΔVr is more than 80 V.

The evaluation standard for the stability of electric properties in H/H condition is as follows:
A: Excellent. ΔV0 is at most 15 V, and ΔVr is at most 105 V;
B: Good. ΔV0 is at most 15 V, and ΔVr is more than 105 V but at most 125 V; or ΔV0 is more than 15 V but at most 30 V, and ΔVr is at most 105 V;
C: Average with no problem in practical use. ΔV0 is more than 15 V but at most 30 V, and ΔVr is more than 105 V but at most 125 V; and
D: Not good. ΔV0 is more than 30 V, or ΔVr is more than 125 V.

The test results in the L/L condition and in the H/H condition were combined, and the stability of the electric properties of the photoreceptor tested was totally evaluated. The standard for overall evaluation of the stability of electric properties is as follows:
A: Excellent. Both in the L/L condition and in the H/H condition, it is excellent (A);
B: Good. Either in the L/L condition or in the H/H condition, it is good (B), and in the other condition, it is excellent (A) or good (B);
C: Average with no problem in practical use. Either in the L/L condition or in the H/H condition, it is average with no problem in practical use (C), and in the other condition, it is not “no good (D)”; and
D: Not good. Either in the L/L condition or in the H/H condition, or in both conditions, it is not good (D).

(c) Overall Capability of Photoreceptor:

The result of the test for oxidizing gas resistance and the result of the test for overall stability of electric properties were combined, and the capability of the photoreceptor tested was totally evaluated. The standard for the overall evaluation is as follows:
A: Excellent. Both the oxidizing gas resistance and the stability of electric properties are excellent (A);
B: Good. Either one of the oxidizing gas resistance or the stability of electric properties is good (B), and the other is excellent (A) or good (B);
C: Average with no problem in practical use. Either one of the oxidizing gas resistance or the stability of electric properties is average with no problem in practical use (C), and the other is not “no good (D)”; and
D: Not good. Either one of or both the oxidizing gas resistance and the stability of electric properties are not good (D).

The test results are shown in Table 2. In Table 2, the undercoat layer is abbreviated to UC; the charge transporting layer is to CT; and the charge generating layer is to CG.

TABLE 2

| | Additive | | | | Oxidizing Gas Resistance | | | |
|---|---|---|---|---|---|---|---|---|
| | | | | ratio to | | Charge | | |
| | | layer with | | solid | initial charge | retentiveness | | |
| | | additive | amount | content of | retentiveness | variation | image | |
| Photoreceptor | compound | added | (wt. pt.) | UC (wt. %) | DD₀ | ΔDD | quality | evaluation |
| Example 1 | No. 1 | UC | 0.3 | 4.8 | 89.0 | 2.1 | A | A |
| Example 2 | No. 1 | UC | 0.7 | 10 | 88.0 | 1.9 | A | A |
| Example 3 | No. 1 | UC | 0.9 | 13 | 88.9 | 1.5 | A | A |
| Example 4 | No. 1 | UC | 0.006 | 0.1 | 89.3 | 5.8 | B | B |
| Example 5 | No. 2 | UC | 0.3 | 4.8 | 88.2 | 3.3 | B | B |
| Example 6 | No. 3 | UC | 0.3 | 4.8 | 88.4 | 3.0 | B | B |
| Example 7 | No. 4 | UC | 0.3 | 4.8 | 89.0 | 3.0 | B | B |
| Example 8 | No. 5 | UC | 0.3 | 4.8 | 89.1 | 5.5 | B | B |
| Example 9 | No. 6 | UC | 0.3 | 4.8 | 88.7 | 4.6 | B | B |
| Example 10 | No. 7 | UC | 0.3 | 4.8 | 89.1 | 4.9 | B | B |
| Example 11 | No. 8 | UC | 0.3 | 4.8 | 88.5 | 4.8 | B | B |
| Example 12 | No. 1 | UC | 2.8 | 32 | 89.0 | 1.2 | A | A |
| Example 13 | No. 1 | UC | 0.0048 | 0.08 | 88.0 | 6.5 | C | C |
| Comparative | no | — | — | — | 87.0 | 9.2 | D | D |
| Example 1 | | | | | | | | |
| Comparative | No. 1 | CT | 5 | — | 86.0 | 2.2 | A | A |
| Example 2 | | | | | | | | |
| Comparative | No. 1 | CG | 7.5 | — | 86.5 | 4.6 | B | B |
| Example 3 | | | | | | | | |
| Comparative | BHT | CT | 5 | — | 85.5 | 7.5 | D | D |
| Example 4 | | | | | | | | |
| Comparative | Structural | UC | 0.3 | 4.8 | 86.0 | 7.0 | D | D |
| Example 5 | formula | | | | | | | |
| | (g) | | | | | | | |

| | Stability of Electric Properties | | | | | | | | | | | |
|---|---|---|---|---|---|---|---|---|---|---|---|---|
| | L/L condition | | | | | H/H condition | | | | | Subtotal | Overall |
| Photoreceptor | V0₁ | ΔV0 | Vr₁ | ΔVr | Evaluation | V0₁ | ΔV0 | Vr₁ | ΔVr | Evaluation | evaluation | Evaluation |
| Example 1 | −670 | 20 | −42 | 48 | A | −660 | 1 | −28 | 90 | A | A | A |
| Example 2 | −655 | 29 | −52 | 48 | A | −650 | 4 | −38 | 95 | A | A | A |
| Example 3 | −648 | 41 | −63 | 53 | B | −645 | 9 | −43 | 115 | B | B | B |
| Example 4 | −668 | 30 | −50 | 40 | A | −660 | 10 | −30 | 74 | A | A | B |
| Example 5 | −675 | 31 | −52 | 45 | A | −665 | 12 | −38 | 92 | A | A | B |
| Example 6 | −672 | 33 | −43 | 45 | A | −659 | 13 | −33 | 108 | B | B | B |
| Example 7 | −680 | 25 | −42 | 44 | A | −654 | 3 | −29 | 101 | A | A | B |
| Example 8 | −665 | 22 | −50 | 46 | A | −658 | 2 | −36 | 109 | B | B | B |
| Example 9 | −663 | 30 | −38 | 42 | A | −657 | 5 | −24 | 89 | A | A | B |
| Example 10 | −660 | 28 | −48 | 41 | A | −655 | 5 | −37 | 87 | A | A | B |
| Example 11 | −668 | 30 | −50 | 45 | A | −860 | 3 | −30 | 108 | B | B | B |
| Example 12 | −680 | 52 | −50 | 60 | C | −662 | 18 | −36 | 123 | C | C | C |
| Example 13 | −670 | 28 | −60 | 50 | A | −650 | 20 | −40 | 102 | B | B | C |
| Comparative | −673 | 70 | −60 | 60 | C | −660 | 30 | −30 | 118 | C | C | D |
| Example 1 | | | | | | | | | | | | |
| Comparative | −650 | 72 | −61 | 65 | C | −662 | 28 | −40 | 126 | D | D | D |
| Example 2 | | | | | | | | | | | | |
| Comparative | −657 | 69 | −58 | 65 | C | −659 | 27 | −35 | 130 | D | D | D |
| Example 3 | | | | | | | | | | | | |
| Comparative | −670 | 37 | −59 | 29 | B | −600 | 18 | −35 | 68 | B | B | D |
| Example 4 | | | | | | | | | | | | |
| Comparative | −660 | 102 | −50 | 23 | D | −648 | 57 | −30 | 50 | D | D | D |
| Example 5 | | | | | | | | | | | | |

Comparing Examples 1 to 13 with Comparative Example 1 confirms the following: the photoreceptors of Examples 1 to 13 in which an amine compound expressed by the general formula (1) is added to the undercoat layer have better oxidizing gas resistance and better stability of electric properties and have better electric properties in repeated use, than the photoreceptor of Comparative Example 1 in which an amine compound expressed by the general formula (1) is not added to the undercoat layer.

Comparing Examples 1 to 13 with Comparative Examples 2 and 3 confirms the following: the photoreceptors of Comparative Examples 2 and 3 in which an amine compound expressed by the general formula (1) is added to the charge transporting layer or the charge generating layer have relatively good oxidizing gas resistance, but are inferior to the photoreceptors of Examples 1 to 13 in that the charge potential variation ΔV0 in repeated use thereof is great in both the L/L condition and the H/H condition and therefore the charge stability is not good, and the residual potential variation ΔVr thereof is large and therefore the responsibility stability thereof is not good.

Comparing Examples 1 to 13 with Comparative Example 4 confirms the following: the photoreceptor of Comparative Example 4 in which a hindered phenol-type antioxidant, Sumilizer BHT is added to the charge transporting layer is inferior to the photoreceptors of Examples 1 to 13 in that the charge retentiveness variation ADD thereof is large, the image quality thereof is not good (D), and the oxidizing gas resistance thereof is insufficient.

Comparing Examples 1 to 13 with Comparative Example 5 confirms the following: the photoreceptor of Comparative Example 5 in which a hindered amine-type antioxidant expressed by the structural formula (9) not corresponding to the amine compound expressed by the general formula (1) is used is inferior to the photoreceptors of Examples 1 to 13 in that the charge retentiveness variation ADD thereof is large, the image quality thereof is not good (D), and the oxidizing gas resistance thereof is insufficient. In addition, the photoreceptor of Comparative Example 5 is also inferior to the photoreceptors of Examples 1 to 13 in that the charge potential variation ΔV0 in repeated use thereof in both the L/L condition and the H/H condition is large and the charge stability thereof is not good.

Comparing the Examples 1 to 11 with Example 12 confirms the following: the photoreceptors of Examples 1 to 11 in which the content of the amine compound expressed by the general formula (1) in the undercoat layer falls within a range of from 0.1 to 30% by weight of the total solid content of the layer are better than the photoreceptor of Example 12 in which the content of the amine compound expressed by the general formula (1) in the undercoat layer is larger than the range, in that the charge potential variation ΔV0 in repeated use thereof in both the L/L condition and the H/H condition is small and therefore the charge stability thereof is good, and in addition, the residual potential variation ΔVr thereof is also small and therefore the responsibility stability thereof is good. Comparing Examples 1, 2 and 5 to 11 with Example 3 confirms the following: the photoreceptors of Examples 1, 2 and 5 to 11 in which the content of the amine compound in the undercoat layer falls within a range of from 1 to 10% by weight of the total solid content of the layer are better than the photoreceptor of Example 3 in which the content of the amine compound in the undercoat layer is larger than 10% by weight of the total solid content of the layer in that the charge potential variation ΔV0 in repeated use thereof in both the L/L condition and the H/H condition is small and therefore the charge stability thereof is good, and in addition, the residual potential variation ΔVr thereof is also small and therefore the responsibility stability thereof is good.

Comparing Examples 1 to 11 with Example 13 confirms the following: the photoreceptors of Examples 1 to 11 in which the content of the amine compound expressed by the general formula (1) in the undercoat layer falls within a range of from 0.1 to 30% by weight of the total solid content of the layer are better than the photoreceptor of Example 13 in which the content of the amine compound expressed by the general formula (1) in the undercoat layer is smaller than the range, in that the charge retentiveness variation ΔDD thereof is small, the image quality thereof is excellent (A) or good (B), and the oxidizing gas resistance thereof is good. Comparing Examples 1, 2 and 5 to 11 with Example 4 confirms the following: The photoreceptors of Examples 1, 2 and 5 to 11 in which the content of the amine compound in the undercoat layer falls within a range of from 1 to 10% by weight of the total solid content of the layer are better than the photoreceptor of Example 4 in which the content of the amine compound in the undercoat layer is smaller than 1% by weight of the total solid content of the layer in that the oxidizing gas resistance thereof is better.

Comparing Example 1 with Examples 5 to 11 confirms the following: among the amine compounds expressed by the general formula (1), a tribenzylamine structure-having amine compound expressed by the structural formula (1a) is more effective in providing photoreceptors having better oxidizing gas resistance and better stability of electric properties.

As described hereinabove, when an amine compound expressed by the general formula (1) is added to the undercoat layer thereof, then the electrophotographic photoreceptor may have good electric properties such as chargeability and responsibility, and may have good oxidizing gas resistance, and in addition, it may have good property stability in that its initial good electric properties do not worsen even in repeated use thereof.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. An electrophotographic photoreceptor comprising:
a conductive support formed of a conductive material;
a photosensitive layer provided on the conductive support and containing a charge generating substance and a charge transporting substance; and
an undercoat layer provided between the conductive support and the photosensitive layer and containing an amine compound expressed by the following general formula (1): 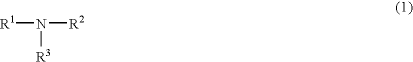
wherein R¹ and R² each represent an optionally-substituted aryl, heterocyclic, aralkyl, alkyl, cycloalkyl or heterocycloalkyl group; and R³ represents an optionally-substituted aralkyl, alkyl or cycloalkyl group, or a hydrogen atom.

2. The electrophotographic photoreceptor of claim 1, wherein in the general formula (1), R¹ and R² each represent an optionally-substituted aryl or aralkyl group, and R³ represents an optionally-substituted aralkyl group, an optionally-substituted alkyl group having from 1 to 4 carbon atoms, or a hydrogen atom.

3. The electrophotographic photoreceptor of claim 1, wherein in the general formula (1), R¹, R² and R³ each represent an optionally-substituted aralkyl group.

4. The electrophotographic photoreceptor of claim 1, wherein the amine compound expressed by the general formula (1) is an amine compound expressed by the following structural formula (1a):

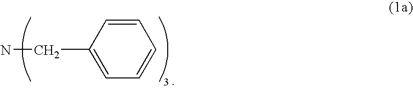

5. The electrophotographic photoreceptor of claim 1, wherein a content of the amine compound expressed by the general formula (1) to be in the undercoat layer is 0.1% by weight or more and 30% by weight or less of the total solid content of the undercoat layer.

6. The electrophotographic photoreceptor of claim 5, wherein the content of the amine compound expressed by the general formula (1) to be in the undercoat layer is 1% by weight or more and 10% by weight or less of the total solid content of the undercoat layer.

7. An image forming apparatus comprising:
the electrophotographic photoreceptor of claim 1;
charging means for charging the electrophotographic photoreceptor;
exposure means for exposing the charged electrophotographic photoreceptor to light; and
developing means for developing the electrostatic latent image formed through exposure.
